(19) United States
(12) Patent Application Publication
(10) Pub. No.: US 2025/0061518 A1
(43) Pub. Date: Feb. 20, 2025

(54) Real-Time System Progression Optimizer Apparatuses, Processes and Systems

(71) Applicant: FMR LLC, Boston, MA (US)

(72) Inventors: Shaina Louise Race Bennett, Raleigh, NC (US); Igor Halperin, Samford, CT (US); Krithika Muthusrbramanian, Cary, NC (US); Radhika Ramakirshnan, Cary, NC (US); Morgan Mcintyre, Whitsett, NC (US); Brent Robert Calabria, Wendell, NC (US); Nour EI Hoda Farhat, Morrisville, NC (US); Shailendra Kumar, Hopkinton, MA (US)

(21) Appl. No.: 18/235,774

(22) Filed: Aug. 18, 2023

(51) Int. Cl. G06Q 40/06

(52) U.S. Cl. CPC G06Q 40/06

(57) ABSTRACT

The Real-Time System Progression Optimizer Apparatuses, Processes and Systems (“RTSPO”) transforms system progression simulation input, system progression simulation update input datastructure/inputs via RTSPO components into system progression simulation output, system progression simulation update output outputs. A system progression simulation request datastructure structured as specifying a set of initial scenario parameters values for a set of scenario parameters is obtained. A set of parameter evaluation values for each scenario parameter in the set of scenario parameters is determined. A set of scenario evaluation points is determined. A scenario result value for each scenario evaluation point is computed via a system progression simulation. A set of surface descriptor datastructures is determined. A scenario evaluation datastructure structured as specifying an evaluation function determined via interpolation is generated for each surface descriptor datastructure. A scenario result value for the set of initial scenario parameters values is determined via a matching scenario evaluation datastructure.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address information technology, and more particularly, include Real-Time System Progression Optimizer Apparatuses, Processes and Systems.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. § 112.

### BACKGROUND

Information technology allows users to access streams of information through various user interfaces. Databases can track assets such as physical inventory, equity shares, accounts receivable/payable, debts/loans and derivatives thereof. Some assets have stable values while others vary greatly, the various assets sometimes generating income streams, while other times appreciate/depreciate. These different assets have different risk exposures and may be attractive to different types of owners. People own all types of assets, some of which are secured instruments to underlying assets. People have used exchanges to facilitate trading and selling of such assets. Computer information systems, such as NAICO-NET, Trade*Plus and E*Trade allowed owners to trade securities assets electronically.

### BRIEF DESCRIPTION OF THE DRAWINGS

Appendices and/or drawings illustrating various, non-limiting, example, innovative aspects of the Real-Time System Progression Optimizer Apparatuses, Processes and Systems (hereinafter “RTSPO”) disclosure, include:

FIG. 1 shows non-limiting, example embodiments of a datagraph illustrating data flow(s) for the RTSPO;

FIG. 2 shows non-limiting, example embodiments of a logic flow illustrating a real-time system progression simulating (RTSPS) component for the RTSPO;

FIG. 3 shows non-limiting, example embodiments of a screenshot illustrating user interface(s) of the RTSPO;

FIG. 4 shows non-limiting, example embodiments of a screenshot illustrating user interface(s) of the RTSPO;

FIGS. 5A-5C (collectively FIG. 5) show non-limiting, example embodiments of implementation case(s) for the RTSPO;

FIG. 6 shows non-limiting, example embodiments of implementation case(s) for the RTSPO;

FIG. 7 shows non-limiting, example embodiments of implementation case(s) for the RTSPO;

FIGS. 8A-8B (collectively FIG. 8) show non-limiting, example embodiments of implementation case(s) for the RTSPO;

FIG. 9 shows non-limiting, example embodiments of implementation case(s) for the RTSPO;

FIG. 10 shows a block diagram illustrating non-limiting, example embodiments of a RTSPO controller.

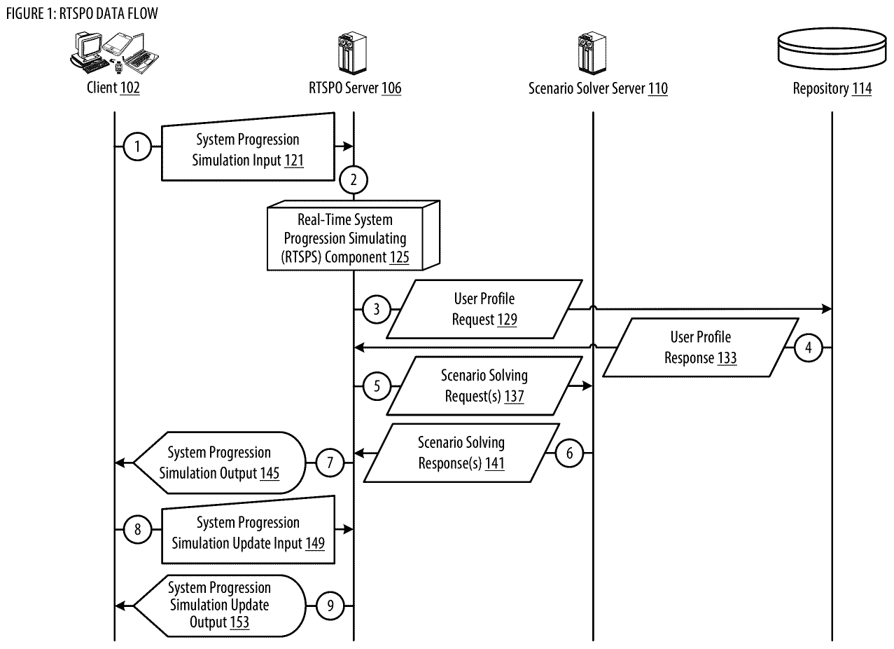

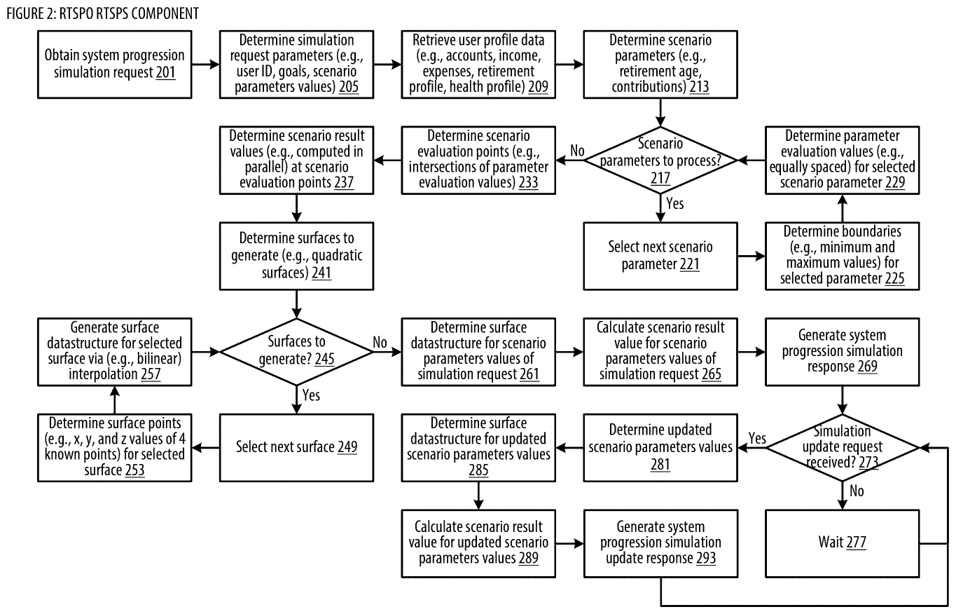

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citations and/or reference numbers are not necessarily sequences but rather just example orders that may be rearranged and other orders are contemplated. Citation number suffixes may indicate that an earlier introduced item has been re-referenced in the context of a later figure and may indicate the same item, evolved/modified version of the earlier introduced item, etc., e.g., server 199 of FIG. 1 may be a similar server 299 of FIG. 2 in the same and/or new context.

### DETAILED DESCRIPTION

The Real-Time System Progression Optimizer Apparatuses, Processes and Systems (hereinafter “RTSPO”) transforms system progression simulation input, system progression simulation update input datastructure/inputs, via RTSPO components (e.g., RTSPS, etc. components), into system progression simulation output, system progression simulation update output outputs. The RTSPO components, in various embodiments, implement advantageous features as set forth below.

### INTRODUCTION

The RTSPO provides unconventional features (e.g., a set of surface datastructures that facilitate real-time interaction with parameters of a system progression simulation) that were never before available in information technology.

Users set financial goals for retirement and create a baseline financial plan to achieve the goal. Many times, they do not have a successful plan, resulting in income shortfalls during retirement period. Users could take many actions to meet their goal: change their retirement age, contribute more, lower their retirement expenses, adjust their asset mix, buy annuities, etc. Adjustments could be made simultaneously across multiple parameters, resulting in an innumerable number of solutions for a successful retirement plan. In one embodiment, the RTSPO provides a user with various possible combinations of actions in multiple dimensions that could be explored using a what-if scenario modelling tool, to achieve a successful retirement plan (e.g., to identify actionable solutions to make the user's retirement plan successful).

What-if scenario analysis (WISA) of retirement plans may be based on simulated financial projections in which the user might selectively change a plan parameter, such as retirement age, and wait for a simulation to return the updated plan forecast. The wait time involved for the simulated forecast prohibits real-time interaction with plan parameters. In one embodiment, the RTSPO determines a set of optimal scenarios that are developed ahead of time in a functional surface that allows for accurate real-time interaction with plan parameters. Users may quickly navigate and explore various combinations of the retirement plan parameters that may provide a successful plan.

In one embodiment, the RTSPO creates a three-dimensional (or extended to multi-dimensional) solution space of successful retirement plans using spline interpolation. This provides users an opportunity to see the impact of multiple dimensions at the same time. In one implementation, to provide users with an interactive experience that allows them to see how changes to their retirement plan (e.g., increasing their contributions and/or delaying retirement) would affect their plan, the RTSPO uses bilinear interpolation to approximate the projected retirement income value for a range of contributions and retirement ages. This achieves the desired functionality because the result is a functional form that accurately outputs projected retirement income (e.g., at a given market confidence) using contributions and retirement age as input. In some implementations, a scenario solver may be utilized to project retirement income values for specified scenarios (e.g., at specified evaluation points), such as Athena backend projection engine that takes in financial planning data (e.g., retirement age, incomes, accounts, expenses) and simulates cash flow projection till plan-to age at the given market confidence (e.g., 90%).

In some embodiments, the RTSPO may be utilized to create an interactive solution for any backend system that is compute and/or time intensive. Examples include weather modelling systems, inventory tracking systems, pricing systems, and any other output for which simulation may be used.

In some embodiments, the RTSPO may be utilized to implement anomaly detection for complex systems. Complex systems are difficult to debug, particularly when response times from a system are long. However, if there is any expectation of smoothness of the result as inputs are varied continuously, the RTSPO may help find “bugs” in the system that create violations of that expectation. Any pervasive bug in the system which creates irregular surfaces, such as sharp cliffs or wild variation, may often be detected by checking error rates at the center points of the grid of spline values, or by examining any grid area with anomalous rates of change. Whether the spline used is bilinear or cubic or some higher-order polynomial, the resulting surface may be analyzed for strange behavior in the system to detect anomalies.

### RTSPO

FIG. 1 shows non-limiting, example embodiments of a datagraph illustrating data flow(s) for the RTSPO. In FIG. 1, a client 102 (e.g., of a user) may send a system progression simulation input 121 to a RTSPO server 106 to facilitate generation of a system progression simulation (e.g., retirement plan simulation) and/or generation of a system progression simulation result (e.g., retirement analysis) for specified initial scenario parameters values. For example, the client may be a desktop, a laptop, a tablet, a smartphone, a smartwatch, and/or the like that is executing a client application. In one implementation, the system progression simulation input may include data such as a request identifier, simulation parameters, and/or the like. In one embodiment, the client may provide the following example system progression simulation input, substantially in the form of a (Secure) Hypertext Transfer Protocol (“HTTP(S)”) POST message including extensible Markup Language (“XML”) formatted data, as provided below:

```
POST /authrequest.php HTTP/1.1
Host: www.server.com
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
      <user_account_credentials>
          <user_name>JohnDaDoeDoeDoooe@gmail.com</user_name>
          <password>abc123</password>
          //OPTIONAL <cookie>cookieID</cookie>
          //OPTIONAL <digital_cert_link>www.mydigitalcertificate.com/
JohnDoeDaDoeDoe@gmail.com/mycertifcate.dc</digital_cert_link>
          //OPTIONAL <digital_certificate>_DATA_</digital_certificate>
      </user_account_credentials>
  </user_accounts_details>
  <client_details> //iOS Client with App and Webkit
          //it should be noted that although several client details
          //sections are provided to show example variants of client
          //sources, further messages may include only one to save
          //space
      <client_IP>10.0.0.123</client_IP>
      <user_agent_string>Mozilla/5.0 (iPhone; CPU iPhone OS 7_1_1 like Mac
OS X) AppleWebKit/537.51.2 (KHTML, like Gecko) Version/7.0 Mobile/11D201
Safari/9537.53</user_agent_string>
      <client_product_type>iPhone6,1</client_product_type>
      <client_serial_number>DNXXX1X1XXXX</client_serial_number>
      <client_UDID>3XXXXXXXXXXXXXXXXXXXXXXXXD</client_UDID>
      <client_OS>iOS</client_OS>
      <client_OS_version>7.1.1</client_OS_version>
      <client_app_type>app with webkit</client_app_type>
      <app_installed_flag>true</app_installed_flag>
      <app_name>RTSPO.app</app_name>
      <app_version>1.0 </app_version>
      <app_webkit_name>Mobile Safari</client_webkit_name>
      <client_version>537.51.2</client_version>
  </client_details>
  <client_details> //iOS Client with Webbrowser
      <client_IP>10.0.0.123</client_IP>
      <user_agent_string>Mozilla/5.0 (iPhone; CPU iPhone OS 7_1_1 like Mac
OS X) AppleWebKit/537.51.2 (KHTML, like Gecko) Version/7.0 Mobile/11D201
Safari/9537.53</user_agent_string>
      <client_product_type>iPhone6,1</client_product_type>
      <client_serial_number>DNXXX1X1XXXX</client_serial_number>
      <client_UDID>3XXXXXXXXXXXXXXXXXXXXXXXXD</client_UDID>
      <client_OS>iOS</client_OS>
      <client_OS_version>7.1.1</client_OS_version>
      <client_app_type>web browser</client_app_type>
      <client_name>Mobile Safari</client_name>
      <client_version>9537.53</client_version>
  </client_details>
  <client_details> //Android Client with Webbrowser
      <client_IP>10.0.0.123</client_IP>
      <user_agent_string>Mozilla/5.0 (Linux; U; Android 4.0.4; en-us; Nexus
S Build/IMM76D) AppleWebKit/534.30 (KHTML, like Gecko) Version/4.0 Mobile
Safari/534.30</user_agent_string>
      <client_product_type>Nexus S</client_product_type>
      <client_serial_number>YXXXXXXXXZ</client_serial_number>
      <client_UDID>FXXXXXXXXX-XXXX-XXXX-XXXX-XXXXXXXXXXXXX</client_UDID>
      <client_OS>Android</client_OS>
      <client_OS_version>4.0.4</client_OS_version>
      <client_app_type>web browser</client_app_type>
      <client_name>Mobile Safari</client_name>
      <client_version>534.30</client_version>
  </client_details>
  <client_details> //Mac Desktop with Webbrowser
      <client_IP>10.0.0.123</client_IP>
      <user_agent_string>Mozilla/5.0 (Macintosh; Intel Mac OS X 10_9_3)
AppleWebKit/537.75.14 (KHTML, like Gecko) Version/7.0.3
Safari/537.75.14</user_agent_string>
      <client_product_type>MacPro5,1</client_product_type>
      <client_serial_number>YXXXXXXXXZ</client_serial_number>
      <client_UDID>FXXXXXXXXX-XXXX-XXXX-XXXX-XXXXXXXXXXXXX</client_UDID>
      <client_OS>Mac OS X</client_OS>
      <client_OS_version>10.9.3</client_OS_version>
      <client_app_type>web browser</client_app_type>
      <client_name>Mobile Safari</client_name>
      <client_version>537.75.14</client_version>
  </client_details>
  <system_progression_simulation_input>
    <request_identifier>ID_request_1</request_identifier>
    <simulation_parameters>
      <goal_type>TYPE_RETIREMENT</goal_type>
      <user_identifier>ID_user_1</user_identifier>
      <simulation_settings>
        <plan_to_age>96</plan_to_age>
        <market_confidence>90%</market_confidence>
      </simulation_settings>
      <initial_scenario_parameters>
        <retirement_age>66</retirement_age>
        <contributions>583 per month to 401K</contributions>
      </initial_scenario_parameters>
    </simulation_parameters>
  </system_progression_simulation_input>
</auth_request>
```

A real-time system progression simulating (RTSPS) component 125 may utilize data provided in the system progression simulation input to generate a system progression simulation and/or to generate a system progression simulation result for specified initial scenario parameters values. See FIG. 2 for additional details regarding the RTSPS component.

The RTSPO server 106 may send a user profile request 129 to a repository 114 to retrieve user profile data associated with the user. In one implementation, the user profile request may include data such as a request identifier, specification of requested user profile data, and/or the like. In one embodiment, the RTSPO server may provide the following example user profile request, substantially in the form of a HTTP(S) POST message including XML-formatted data, as provided below:

```
POST /user_profile_request.php HTTP/1.1
Host: www.server.com
Content-Type: Application/XML
Content-Length: 667
<?XML version = “1.0” encoding = “UTF-8”?>
<user_profile_request>
  <request_identifier>ID_request_2</request_identifier>
  <requested_user_profile_data>
    USER, ACCOUNT, INCOME, EXPENSE
  </requested_user_profile_data>
</user_profile_request>
```

The repository 114 may send a user profile response 133 to the RTSPO server 106 with the requested user profile data. In one implementation, the user profile response may include data such as a response identifier, the requested user profile data, and/or the like. In one embodiment, the repository may provide the following example user profile response, substantially in the form of a HTTP(S) POST message including XML-formatted data, as provided below:

```
POST /user_profile_response.php HTTP/1.1
Host: www.server.com
Content-Type: Application/XML
Content-Length: 667
<?XML version = “1.0” encoding = “UTF-8”?>
<user_profile_response>
  <response_identifier>ID_response_2</response_identifier>
  <user>
    <date_of_birth>1993-02-17</date_of_birth>
    <gender>FEMALE</gender>
    <state>PA</state>
  </user>
  <accounts>
    <account>
      <account_identifier>ID_account_1</account_identifier>
      <account_type>BROKERAGE</account_type>
      <account_balance>67661.08</account_balance>
    </account>
    <account>
      <account_identifier>ID_account_2</account_identifier>
      <account_type>401K</account_type>
      <account_balance>3150.0</account_balance>
    </account>
  </accounts>
  <incomes>
    <income>
      <income_identifier>ID_income_1</income_identifier>
      <income_type>SALARY</income_type>
      <income_amount>63000.0</income_amount>
    </income>
    <income>
      <income_identifier>ID_income_2</income_identifier>
      <income_type>SOCIAL_SECURITY</income_type>
      <income_amount>22500.0</income_amount>
    </income>
  </incomes>
  <expenses>
    <expense>
      <expense_identifier>ID_expense_1</expense_identifier>
      <expense_type>LIFESTYLE</expense_type>
      <expense_amount>89184.0</expense_amount>
    </expense>
  </expenses>
</user_profile_response>
```

The RTSPO server 106 may send a scenario solving request(s) 137 to a scenario solver server 110 to project system progression (e.g., retirement income values) for specified scenarios (e.g., at specified evaluation points). It is to be understood that, in various implementations, one scenario solving request (e.g., for the specified scenarios) or multiple scenario solving requests (e.g., one for each specified scenario) may be sent. In one implementation, the scenario solving request(s) may include data such as a request identifier, simulation settings, user profile data, scenario parameters for each specified scenario, and/or the like. In one embodiment, the RTSPO server may provide the following example scenario solving request(s), substantially in the form of a HTTP(S) POST message including XML-formatted data, as provided below:

```
POST /scenario_solving_request.php HTTP/1.1
Host: www.server.com
Content-Type: Application/XML
Content-Length: 667
<?XML version = “1.0” encoding = “UTF-8”?>
<scenario_solving_request>
  <request_identifier>ID_request_3</request_identifier>
  <simulation_settings>
    <plan_to_age>96</plan_to_age>
    <market_confidence>90%</market_confidence>
    <solver_type>EXPENSE</solver_type>
    <method_type>BISECTION</method_type>
  </simulation_settings>
  <user>
    <date_of_birth>1993-02-17</date_of_birth>
    <gender>FEMALE</gender>
    <state>PA</state>
  </user>
  <accounts>
    <account>
      <account_identifier>ID_account_1</account_identifier>
      <account_type>BROKERAGE</account_type>
      <account_balance>67661.08</account_balance>
    </account>
    <account>
      <account_identifier>ID_account_2</account_identifier>
      <account_type>401K</account_type>
      <account_balance>3150.0</account_balance>
    </account>
  </accounts>
  <incomes>
    <income>
      <income_identifier>ID_income_1</income_identifier>
      <income_type>SALARY</income_type>
      <income_amount>63000.0</income_amount>
    </income>
    <income>
      <income_identifier>ID_income_2</income_identifier>
      <income_type>SOCIAL_SECURITY</income_type>
      <income_amount>22500.0</income_amount>
    </income>
  </incomes>
  <expenses>
    <expense>
      <expense_identifier>ID_expense_1</expense_identifier>
      <expense_type>LIFESTYLE</expense_type>
      <expense_amount>89184.0</expense_amount>
    </expense>
  </expenses>
  <scenarios>
    <scenario>
      <scenario_identifier>ID_scenario_1</scenario_identifier>
      <scenario_parameters>
        <retirement_age>66</retirement_age>
        <contributions>583 per month to 401K</contributions>
      </scenario_parameters>
    </scenario>
    <scenario>
      <scenario_identifier>ID_scenario_2</scenario_identifier>
      <scenario_parameters>
        <retirement_age>66</retirement_age>
        <contributions>850 per month to 401K</contributions>
      </scenario_parameters>
    </scenario>
    ...
    <scenario>
      <scenario_identifier>ID_scenario_5</scenario_identifier>
      <scenario_parameters>
        <retirement_age>66</retirement_age>
        <contributions>1667 per month to 401K</contributions>
      </scenario_parameters>
    </scenario>
    <scenario>
      <scenario_identifier>ID_scenario_6</scenario_identifier>
      <scenario_parameters>
        <retirement_age>67</retirement_age>
        <contributions>583 per month to 401K</contributions>
      </scenario_parameters>
    </scenario>
    <scenario>
      <scenario_identifier>ID_scenario_7</scenario_identifier>
      <scenario_parameters>
        <retirement_age>67</retirement_age>
        <contributions>850 per month to 401K</contributions>
      </scenario_parameters>
    </scenario>
    ...
    <scenario>
      <scenario_identifier>ID_scenario_9</scenario_identifier>
      <scenario_parameters>
        <retirement_age>67</retirement_age>
        <contributions>1383 per month to 401K</contributions>
      </scenario_parameters>
    </scenario>
    <scenario>
      <scenario_identifier>ID_scenario_10</scenario_identifier>
      <scenario_parameters>
        <retirement_age>67</retirement_age>
        <contributions>1667 per month to 401K</contributions>
      </scenario_parameters>
    </scenario>
    ...
    <scenario>
      <scenario_identifier>ID_scenario_21</scenario_identifier>
      <scenario_parameters>
        <retirement_age>70</retirement_age>
        <contributions>583 per month to 401K</contributions>
      </scenario_parameters>
    </scenario>
    <scenario>
      <scenario_identifier>ID_scenario_22</scenario_identifier>
      <scenario_parameters>
        <retirement_age>70</retirement_age>
        <contributions>850 per month to 401K</contributions>
      </scenario_parameters>
    </scenario>
    ...
    <scenario>
      <scenario_identifier>ID_scenario_25</scenario_identifier>
      <scenario_parameters>
        <retirement_age>70</retirement_age>
        <contributions>1667 per month to 401K</contributions>
      </scenario_parameters>
    </scenario>
  </scenarios>
</scenario_solving_request>
```

The scenario solver server 110 may send a scenario solving response(s) 141 to the RTSPO server 106 to provide projected system progression data (e.g., retirement income values) for the specified scenarios (e.g., at the specified evaluation points). It is to be understood that, in various implementations, one scenario solving response (e.g., for the specified scenarios) or multiple scenario solving responses (e.g., one for each specified scenario) may be sent. In one implementation, the scenario solving response(s) may include data such as a response identifier, projected system progression data, and/or the like. In one embodiment, the scenario solver server may provide the following example scenario solving response(s), substantially in the form of a HTTP(S) POST message including XML-formatted data, as provided below:

```
POST /scenario_solving_response.php HTTP/1.1
Host: www.server.com
Content-Type: Application/XML
Content-Length: 667
<?XML version = “1.0” encoding = “UTF-8”?>
<scenario_solving_response>
  <response_identifier>ID_response_3</response_identifier>
  <scenarios>
    <scenario>
      <scenario_identifier>ID_scenario_1</scenario_identifier>
      <nominal_projections>
        <projection>
          <year>2023</year>
          <balance_begin>67661.08</balance_begin>
          <balance_end>65517.84</balance_end>
          <income>63000.0</income>
          <expense>0</expense>
          <withdrawal>0</withdrawal>
        </projection>
        <projection>
          <year>2024</year>
          <balance_begin>65517.84</balance_begin>
          <balance_end>74088.62</balance_end>
          <income>65519.99</income>
          <expense>0</expense>
          <withdrawal>0</withdrawal>
        </projection>
        ...
        <projection>
          <year>2058</year>
          <balance_begin>1607238.13</balance_begin>
          <balance_end>1744162.81</balance_end>
          <income>248603.60</income> (e.g., last year of work)
          <expense>0</expense>
          <withdrawal>0</withdrawal>
        </projection>
        <projection>
          <year>2059</year>
          <balance_begin>1744162.81</balance_begin>
          <balance_end>1920306.56</balance_end>
          <income>54732.03</income> (e.g., first year of social
          security)
          <expense>167317.08</expense> (e.g., retirement starts)
          <withdrawal>193777.41</withdrawal> (e.g., from accounts)
        </projection>
        ...
        <projection>
          <year>2089</year>
          <balance_begin>211627.19</balance_begin>
          <balance_end>18543.35</balance_end>
          <income>94804.16</income>
          <expense>350958.88</expense>
          <withdrawal>350958.88</withdrawal>
        </projection>
      </nominal_projections>
      <real_projections>
        Projections using real values
      </real_projections>
    </scenario>
    ...
    <scenario>
      <scenario_identifier>ID_scenario_5</scenario_identifier>
      <nominal_projections>
        <projection>
          <year>2023</year>
          <balance_begin>67661.08</balance_begin>
          <balance_end>65517.84</balance_end>
          <income>63000.0</income>
          <expense>0</expense>
          <withdrawal>0</withdrawal>
        </projection>
        <projection>
          <year>2024</year>
          <balance_begin>66517.84</balance_begin>
          <balance_end>76088.62</balance_end>
          <income>65519.99</income>
          <expense>0</expense>
          <withdrawal>0</withdrawal>
        </projection>
        ...
        <projection>
          <year>2058</year>
          <balance_begin>2007238.13</balance_begin>
          <balance_end>2144162.81</balance_end>
          <income>248603.60</income> (e.g., last year of work)
          <expense>0</expense>
          <withdrawal>0</withdrawal>
        </projection>
        <projection>
          <year>2059</year>
          <balance_begin>2144162.81</balance_begin>
          <balance_end>2320306.56</balance_end>
          <income>54732.03</income> (e.g., first year of social
          security)
          <expense>167317.08</expense> (e.g., retirement starts)
          <withdrawal>233777.41</withdrawal> (e.g., from accounts)
        </projection>
        ...
        <projection>
          <year>2089</year>
          <balance_begin>231627.19</balance_begin>
          <balance_end>38543.35</balance_end>
          <income>94804.16</income>
          <expense>350958.88</expense>
          <withdrawal>350958.88</withdrawal>
        </projection>
      </nominal_projections>
      <real_projections>
        Projections using real values
      </real_projections>
    </scenario>
    ...
    <scenario>
      <scenario_identifier>ID_scenario_21</scenario_identifier>
      <nominal_projections>
        <projection>
          <year>2023</year>
          <balance_begin>67661.08</balance_begin>
          <balance_end>65517.84</balance_end>
          <income>63000.0</income>
          <expense>0</expense>
          <withdrawal>0</withdrawal>
        </projection>
        <projection>
          <year>2024</year>
          <balance_begin>65517.84</balance_begin>
          <balance_end>74088.62</balance_end>
          <income>65519.99</income>
          <expense>0</expense>
          <withdrawal>0</withdrawal>
        </projection>
        ...
        <projection>
          <year>2062</year>
          <balance_begin>2138701.47</balance_begin>
          <balance_end>2443875.57</balance_end>
          <income>349771.48</income> (e.g., last year of work)
          <expense>0</expense>
          <withdrawal>0</withdrawal>
        </projection>
        <projection>
          <year>2063</year>
          <balance_begin>2443875.57</balance_begin>
          <balance_end>2401350.98</balance_end>
          <income>60413.93</income> (e.g., first year of social
          security)
          <expense>184686.75</expense> (e.g., retirement starts)
          <withdrawal>213060.52</withdrawal> (e.g., from accounts)
        </projection>
        ...
        <projection>
          <year>2089</year>
          <balance_begin>251627.19</balance_begin>
          <balance_end>58543.35</balance_end>
          <income>114804.16</income>
          <expense>350958.88</expense>
          <withdrawal>350958.88</withdrawal>
        </projection>
      </nominal_projections>
      <real_projections>
        Projections using real values
      </real_projections>
    </scenario>
    ...
    <scenario>
      <scenario_identifier>ID_scenario_25</scenario_identifier>
      <nominal_projections>
        <projection>
          <year>2023</year>
          <balance_begin>67661.08</balance_begin>
          <balance_end>66517.84</balance_end>
          <income>63000.0</income>
          <expense>0</expense>
          <withdrawal>0</withdrawal>
        </projection>
        <projection>
          <year>2024</year>
          <balance_begin>66517.84</balance_begin>
          <balance_end>76088.62</balance_end>
          <income>65519.99</income>
          <expense>0</expense>
          <withdrawal>0</withdrawal>
        </projection>
        ...
        <projection>
          <year>2062</year>
          <balance_begin>2838701.47</balance_begin>
          <balance_end>3443875.57</balance_end>
          <income>349771.48</income> (e.g., last year of work)
          <expense>0</expense>
          <withdrawal>0</withdrawal>
        </projection>
        <projection>
          <year>2063</year>
          <balance_begin>3443875.57</balance_begin>
          <balance_end>3421350.98</balance_end>
          <income>60413.93</income> (e.g., first year of social
          security)
          <expense>184686.75</expense> (e.g., retirement starts)
          <withdrawal>253060.52</withdrawal> (e.g., from accounts)
        </projection>
        ...
        <projection>
          <year>2089</year>
          <balance_begin>291627.19</balance_begin>
          <balance_end>68543.35</balance_end>
          <income>114804.16</income>
          <expense>350958.88</expense>
          <withdrawal>390958.88</withdrawal>
        </projection>
      </nominal_projections>
      <real_projections>
        Projections using real values
      </real_projections>
    </scenario>
  </scenarios>
  <simulation_count>250</simulation_count>
  <engine_type>MONTE_CARLO</engine_type>
</scenario_solving_response>
```

The RTSPO server 106 may send a system progression simulation output 145 to the client 102 to provide the user with a system progression simulation result for specified initial scenario parameters values. In one implementation, the system progression simulation output may include data such as a response identifier, a system progression simulation result, and/or the like. In one embodiment, the RTSPO server may provide the following example system progression simulation output, substantially in the form of a HTTP(S) POST message including XML-formatted data, as provided below:

```
POST /system_progression_simulation_output.php HTTP/1.1
Host: www.server.com
Content-Type: Application/XML
Content-Length: 667
<?XML version = “1.0” encoding = “UTF-8”?>
<system_progression_simulation_output>
  <response_identifier>ID_response_1</response_identifier>
  <system_progression_simulation_result>
    <scenario_identifier>ID_scenario_1</scenario_identifier>
    <scenario_parameters>
      <retirement_age>66</retirement_age>
      <contributions>583 per month to 401K</contributions>
    </scenario_parameters>
    <scenario_results>
      <income>1500</income>
      <expenses>2897</expenses>
      <result_score>51.77%</result_score>
    </scenario_results>
  </system_progression_simulation_result>
</system_progression_simulation_output>
```

The client 102 may send a system progression simulation update input 149 to the RTSPO server 106 to facilitate generation of a system progression simulation result (e.g., retirement analysis) for specified updated scenario parameters values. In one implementation, the system progression simulation update input may include data such as a request identifier, updated scenario parameters values, and/or the like. In one embodiment, the client may provide the following example system progression simulation update input, substantially in the form of a HTTP(S) POST message including XML-formatted data, as provided below:

```
POST /system_progression_simulation_update_input.php HTTP/1.1
Host: www.server.com
Content-Type: Application/XML
Content-Length: 667
<?XML version = “1.0” encoding = “UTF-8”?>
<system_progression_simulation_update_input>
  <request_identifier>ID_request_4</request_identifier>
  <updated_scenario_parameters>
    <retirement_age>67</retirement_age>
    <contributions>1383 per month to 401K</contributions>
  </updated_scenario_parameters>
</system_progression_simulation_update_input>
```

The RTSPO server 106 may send a system progression simulation update output 153 to the client 102 to provide the user with a system progression simulation result for specified updated scenario parameters values. In one implementation, the system progression simulation update output may include data such as a response identifier, a system progression simulation result, and/or the like. In one embodiment, the RTSPO server may provide the following example system progression simulation update output, substantially in the form of a HTTP(S) POST message including XML-formatted data, as provided below:

```
POST /system_progression_simulation_update_output.php HTTP/1.1
Host: www.server.com
Content-Type: Application/XML
Content-Length: 667
<?XML version = “1.0” encoding = “UTF-8”?>
<system_progression_simulation_update_output>
  <response_identifier>ID_response_4</response_identifier>
  <system_progression_simulation_result>
    <scenario_identifier>ID_scenario_9</scenario_identifier>
    <scenario_parameters>
      <retirement_age>67</retirement_age>
      <contributions>1383 per month to 401K</contributions>
    </scenario_parameters>
    <scenario_results>
      <income>2211</income>
      <expenses>2897</expenses>
      <result_score>76.32%</result_score>
    </scenario_results>
  </system_progression_simulation_result>
</system_progression_simulation_update_output>
```

FIG. 2 shows non-limiting, example embodiments of a logic flow illustrating a real-time system progression simulating (RTSPS) component for the RTSPO. In FIG. 2, a system progression simulation request may be obtained at 201. For example, the system progression simulation request may be obtained as a result of a request from a user (e.g., via a system progression simulation input) to generate a system progression simulation (e.g., retirement plan simulation) and/or to generate a system progression simulation result (e.g., retirement analysis) for specified initial scenario parameters values.

Simulation parameters associated with the system progression simulation request may be determined at 205. In one embodiment, simulation parameters may comprise data utilized to configure a scenario solver (e.g., Athena). For example, the simulation parameters may include data such as a user identifier, the user's goals (e.g., retire such that assets and retirement income cover expenses until age 96 with a 90% probability), initial scenario parameters values (e.g., retirement age, contributions to the user's retirement plan), and/or the like. In one implementation, the system progression simulation request may be parsed (e.g., using PHP commands) to determine the simulation parameters (e.g., based on the value of the simulation_parameters field). It is to be understood that, in some embodiments, the simulation parameters may include profile data (e.g., any profile data specified by the user via the system progression simulation input), which may alternatively be retrieved from a repository as discussed with regard to 209.

Profile data associated with the user may be retrieved at 209. In one embodiment, profile data may comprise data utilized by the scenario solver to compute scenario result values for scenarios. For example, the profile data associated with the user may include data such as accounts (e.g., balances of brokerage accounts, retirement accounts, annuities, and/or the like), income (e.g., amounts of work income, social security income, and/or the like), expenses (e.g., amounts of retirement expenses), retirement profile (e.g., lifestyle type and associated expenses, whether the user is already retired), health profile (e.g., life expectancy, amounts of healthcare expenses), and/or the like. In one implementation, the profile data associated with the user may be retrieved from a repository. For example, the profile data may be retrieved via a MySQL database command similar to the following:
SELECT profileData
FROM profiles
WHERE associatedUserID=ID_user_1 AND
   profileType IN (‘ACCOUNTS’, ‘INCOME’, ‘EXPENSES’);
      It is to be understood that, in some embodiments, profile data may be used to adjust and/or calculate other profile data. For example, the user's expenses may be adjusted based on the user's lifestyle type and/or health profile. In another example, a minimum retirement age for the user may be calculated based on the user's retirement profile (e.g., whether the user is already retired and/or when the user retired).

Scenario parameters associated with the system progression simulation request may be determined at 213. In one embodiment, scenario parameters may represent dimensions (e.g., two dimensions) of a multi-dimensional (e.g., three-dimensional) solution space that may be adjusted to compute a result value for the user's goal (e.g., a third dimension corresponding to withdrawals available to cover expenses during retirement). For example, the scenario parameters associated with the system progression simulation request may comprise retirement age (e.g., a first dimension) and contributions (e.g., a second dimension). In one implementation, the scenario parameters associated with the system progression simulation request may be specified via a configuration setting associated with the simulation and/or goal type.

A determination may be made at 217 whether there remain scenario parameters to process. In one implementation, each of the scenario parameters associated with the system progression simulation request may be processed. If there remain scenario parameters to process, the next scenario parameter associated with the system progression simulation request may be selected for processing at 221.

Boundaries (e.g., minimum and/or maximum values) for the selected scenario parameter may be determined at 225. For example, minimum and/or maximum values for retirement age may be determined. In another example, minimum and/or maximum values for contributions may be determined. In one implementation, the boundaries for the selected scenario parameter may be determined using a set of default values (e.g., retirement ages of 66 through 70, contributions between 0) and 22500). In another implementation, the boundaries for the selected scenario parameter may be determined based on the initial scenario parameters values (e.g., retirement ages between the user's specified retirement age and some derived value (e.g., specified retirement age+5 years), contributions from the user's specified contributions level (e.g., 14500 per year) to a maximum allowed level (e.g., 22500 per year).

Parameter evaluation values for the selected scenario parameter may be determined at 229. In one embodiment, parameter evaluation values (e.g., number of values, location of values) may be selected to facilitate providing real-time simulation interaction while minimizing errors associated with result values calculated using generated surface datastructures. In one implementation, the parameter evaluation values for the selected scenario parameter may be equally spaced points along an interval specified by the boundaries for the selected scenario parameter. For example, the parameter evaluation values for retirement age may be integer retirement age values at a specified span (e.g., every 1 year) within the boundaries (e.g., 66, 67, 68, 69, 70). In another example, the parameter evaluation values for contributions may be some specified number of values (e.g. 5 values) within the boundaries (e.g., 14500, 16500, 18500, 20500, 22500).

Scenario evaluation points associated with the system progression simulation request may be determined at 233. In one embodiment, scenario evaluation points may represent scenario parameters of scenarios to be provided to the scenario solver that computes result values (e.g., retirement income values). In one implementation, the scenario evaluation points may be intersections of the parameter evaluation values of the scenario parameters associated with the system progression simulation request. For example, if there are 5 parameter evaluation values for retirement age and 5 parameter evaluation values for contributions, 25 scenario evaluation points may be determined as follows:

| | 66 | 67 | 68 | 69 | 70 |
|---|---|---|---|---|---|
| 14500 | (66, 14500) | (67, 14500) | (68, 14500) | (69, 14500) | (70, 14500) |
| 16500 | (66, 16500) | (67, 16500) | (68, 16500) | (69, 16500) | (70, 16500) |
| 18500 | (66, 18500) | (67, 18500) | (68, 18500) | (69, 18500) | (70, 18500) |
| 20500 | (66, 20500) | (67, 20500) | (68, 20500) | (69, 20500) | (70, 20500) |
| 22500 | (66, 22500) | (67, 22500) | (68, 22500) | (69, 22500) | (70, 22500) |

Scenario result values at the scenario evaluation points may be determined at 237. In one implementation, the scenario solver may be queried to project system progression and/or compute the scenario result values for different scenario evaluation points via one or more scenario solving requests. In one embodiment, the scenario solver may project system progression and/or compute the scenario result values for different scenario evaluation points in parallel (e.g., to improve execution speed). For example, annual withdrawal amounts (e.g., referred to as W₁ through W₂₅) available during retirement years may be provided (e.g., nominal amounts, real amounts) by the scenario solver for each scenario evaluation point via one or more scenario solving responses.

Surfaces to generate for the system progression simulation request may be determined at 241. In one embodiment, the surfaces may be utilized to estimate scenario result values for (e.g., other) scenarios using the computed scenario result values at the scenario evaluation points. In one implementation, the surfaces to generate may depend on the dimensionality of the solution space. For example, for a three-dimensional solution space (e.g., retirement age, contributions, withdrawals), quadratic surfaces connecting 4 surface points of each rectangle in a (e.g., 5 by 5) grid may be determined to be generated (e.g., 16 surfaces) as illustrated by the following surface descriptor datastructures:

| | | | | | | | |
|---|---|---|---|---|---|---|---|
| (66, 14500, | (67, 14500, | (67, 14500, | (68, 14500, | (68, 14500, | (69, 14500, | (69, 14500, | (70, 14500, |
| W₁) | W₆) | W₆) | W₁₁) | W₁₁) | W₁₆) | W₁₆) | W₂₁) |
| (66, 16500, | (67, 16500, | (67, 16500, | (68, 16500, | (68, 16500, | (69, 16500, | (69, 16500, | (70, 16500, |
| W₂) | W₇) | W₇) | W₁₂) | W₁₂) | W₁₇) | W₁₇) | W₂₂) |
| (66, 16500, | (67, 16500, | (67, 16500, | (68, 16500, | (68, 16500, | (69, 16500, | (69, 16500, | (70, 16500, |
| W₂) | W₇) | W₇) | W₁₂) | W₁₂) | W₁₇) | W₁₇) | W₂₂) |
| (66, 18500, | (67, 18500, | (67, 18500, | (68, 18500, | (68, 18500, | (69, 18500, | (69, 18500, | (70, 18500, |
| W₃) | W₈) | W₈) | W₁₃) | W₁₃) | W₁₈) | W₁₈) | W₂₃) |
| (66, 18500, | (67, 18500, | (67, 18500, | (68, 18500, | (68, 18500, | (69, 18500, | (69, 18500, | (70, 18500, |
| W₃) | W₈) | W₈) | W₁₃) | W₁₃) | W₁₈) | W₁₈) | W₂₃) |
| (66, 20500, | (67, 20500, | (67, 20500, | (68, 20500, | (68, 20500, | (69, 20500, | (69, 20500, | (70, 20500, |
| W₄) | W₉) | W₉) | W₁₄) | W₁₄) | W₁₉) | W₁₉) | W₂₄) |
| (66, 20500, | (67, 20500, | (67, 20500, | (68, 20500, | (68, 20500, | (69, 20500, | (69, 20500, | (70, 20500, |
| W₄) | W₉) | W₉) | W₁₄) | W₁₄) | W₁₉) | W₁₉) | W₂₄) |
| (66, 22500, | (67, 22500, | (67, 22500, | (68, 22500, | (68, 22500, | (69, 22500, | (69, 22500, | (70, 22500, |
| W₅) | W₁₀) | W₁₀) | W₁₅) | W₁₅) | W₂₀) | W₂₀) | W₂₅) |

A determination may be made at 245 whether there remain surfaces to generate. In one implementation, a surface datastructure may be generated for each of the determined surfaces to generate for the system progression simulation request. If there remain surfaces to generate, the next surface may be selected for processing at 249.

Surface points for the selected surface may be determined at 253. In one embodiment, the 4 points (e.g., x, y, and z values of 4 known surface points) of a rectangle in the grid corresponding to the selected surface may be determined. In one implementation, the surface points at the scenario evaluation points corresponding to the selected surface may be determined. For example, the following surface points may be determined for the selected surface as illustrated by the following surface descriptor datastructure:

| | |
|---|---|
| (66, 14500, W₁) | (67, 14500, W₆) |
| (66, 16500, W₂) | (67, 16500, W₇) |

A surface datastructure for the selected surface may be generated via interpolation at 257. In one embodiment, the surface datastructure may define a quadratic surface corresponding to the selected surface via a set of scenario evaluation datastructures (e.g., polynomial function definitions). In one implementation, bilinear interpolation may be utilized to generate the surface datastructure for the selected surface. For example, a surface datastructure similar to the following may be generated (e.g., in JSON format) for the selected surface:

Surface Datastructure

```
″surfaceDatastructure″: [
  {
    ″scenarioEvaluationDatastructure″: {
      “identifier”: “ID_evaluator_66_14500_16500”,
      ″coefficients″: {
        ″constant″: −131532.4065864173,
        ″xyCoefficient″: 0.255390333646754,
        ″xcoefficient″: 2654.782518257966,
        ″ycoefficient″: − 14.046468350571512
      },
      ″yvalues″: [
        14500.0,
        16500.0
      ],
      ″zvalues″: [
        84417.9978352652,
        90036.5851754938
      ]
    },
    ″xvalue″: 66.0
  },
  {
    ″scenarioEvaluationDatastructure″: {
      “identifier”: “ID_evaluator_67_14500_16500”,
      ″coefficients″: {
        ″constant″: −251480.3076386144,
        ″xyCoefficient″: 1.0265901395673265E−14,
        ″xcoefficient″: 4344.189575331191,
        ″ycoefficient″: 4.086245338347284
      },
      ″yvalues″: [
        14500.0,
        16500.0
      ],
      ″zvalues″: [
        98830.9513146213,
        107003.441991317
      ]
    },
    ″xvalue″: 67.0
  }
]
```

It is to be understood that, in some implementations, a combined surface datastructure that combines surface data (e.g., for the 16 surfaces) specified via individual surface datastructures for individual surfaces may be utilized instead. For example, a combined surface datastructure similar to the following may be utilized:

Surface Datastructure

```
″surfaceDatastructure″: [
  {
    ″scenarioEvaluationDatastructures″: [
      {
        “identifier”: “ID_evaluator_66_14500_16500”,
        ″coefficients″: {
          ...
        },
        ″yvalues″: [
          14500.0,
          16500.0
        ],
        ″zvalues″: [
          84417.9978352652,
          90036.5851754938
        ]
      },
      ...
      {
        “identifier”: “ID_evaluator_66_20500_22500”,
        ″coefficients″: {
          ...
        },
        ″yvalues″: [
          20500.0,
          22500.0
        ],
        ″zvalues″: [
          103084.876368911,
          108384.225792081
        ]
      },
    ],
    ″xvalue″: 66.0
  },
  ...
  {
    ″scenarioEvaluationDatastructures″: [
      {
        “identifier”: “ID_evaluator_70_14500_16500”,
        ″coefficients″: {
          ...
        },
        ″yvalues″: [
          14500.0,
          16500.0
        ],
        ″zvalues″: [
          121366.594355612,
          131582.207701482
        ]
      },
      ...
      {
        “identifier”: “ID_evaluator_70_20500_22500”,
        ″coefficients″: {
          ...
        },
        ″yvalues″: [
          20500.0,
          22500.0
        ],
        ″zvalues″: [
          136037.492071951,
          144082.287581824
        ]
      },
    ],
    ″xvalue″: 70.0
  }
]
```

A surface datastructure for the initial scenario parameters values of the system progression simulation request may be determined at 261. In one embodiment, a surface datastructure that specifies a scenario evaluation datastructure suitable for evaluating the initial scenario parameters values may be determined. In one implementation, the generated surface datastructure(s) (e.g., including scenario evaluation datastructure(s)) may be parsed (e.g., using PHP commands) to determine a matching surface datastructure. For example, if the initial scenario parameters values are retirement age of 66 and contributions of 14500 per year, a surface datastructure and/or a scenario evaluation datastructure with xvalue of 66 and yvalues whose range includes 14500 (e.g., yvalues with a range of 14500.0 to 16500.0) may be determined (e.g., the scenario evaluation datastructure with identifier ID_evaluator_66_14500_16500).

A scenario result value for the initial scenario parameters values of the system progression simulation request may be calculated at 265. In one embodiment, an evaluation function specified by the determined surface datastructure and/or scenario evaluation datastructure (e.g., via a coefficients datastructure) may be utilized to calculate the scenario result value for the initial scenario parameters values. In one implementation, the initial scenario parameters values (e.g., with retirement age of 66 as an x value and contributions of 14500 as a y value) may be evaluated by the evaluation function to determine the scenario result value (e.g., annual withdrawal amount as a z value). For example, the scenario result value for the initial scenario parameters values may be calculated as follows:

Scenario Result Value Calculation

```
Coefficients datastructure specified by ID_evaluator_66_14500_16500:
  “coefficients”: {
    “constant”: −131532.4065864173,
    “xyCoefficient”: 0.255390333646754,
    “xcoefficient”: 2654.782518257966,
    “ycoefficient”: −14.046468350571512
  }
```

### Evaluation Function:

$$z = constant + x * xcoefficient + y * ycoefficient + x * y * xyCoefficient \\ z = - 13153 2.4065864173 + 66 * 2654.782518257966 + 14500 * ( - 14.046468350571512 ) + 66 * 14500 * 0.255390333646754 \\ z = 84 \; 417.9978352652$$

A system progression simulation response may be generated at 269. In one embodiment, the system progression simulation response may comprise a system progression simulation result (e.g., retirement analysis) for the initial scenario parameters values based on the system progression simulation and/or the scenario result value. For example, the system progression simulation result may specify a result amount (e.g., a monthly withdrawal amount determined as the annual withdrawal amount divided by 12) for the initial scenario parameters values. In another example, the system progression simulation result may specify a result score (e.g., determined as a percentage of monthly expenses covered by the monthly withdrawal amount) for the initial scenario parameters values. In one implementation, the system progression simulation response may be provided to the user via a system progression simulation output.

A determination may be made at 273 whether a system progression simulation update request was received. In one embodiment, the user may send system progression simulation update requests and may be provided with system progression simulation update responses to facilitate real-time interaction with the system progression simulation. If a system progression simulation update request was not received, the RTSPO may wait (e.g., until the user sends another system progression simulation update request (e.g., via a system progression simulation input)) at 277.

If a system progression simulation update request was received, updated scenario parameters values specified via the system progression simulation update request may be determined at 281. In one implementation, the system progression simulation update request may be parsed (e.g., using PHP commands) to determine the updated scenario parameters values (e.g., based on the value of the updated_scenario_parameters field). For example, updated retirement age (e.g., 67) and/or contributions (e.g., 15600) values may be determined.

A surface datastructure for the updated scenario parameters values may be determined at 285. In one embodiment, a surface datastructure that specifies a scenario evaluation datastructure suitable for evaluating the updated scenario parameters values may be determined. In one implementation, the generated surface datastructure(s) (e.g., including scenario evaluation datastructure(s)) may be parsed (e.g., using PHP commands) to determine a matching surface datastructure. For example, if the updated scenario parameters values are retirement age of 67 and contributions of 15600 per year, a surface datastructure and/or a scenario evaluation datastructure with xvalue of 67 and yvalues whose range includes 15600 (e.g., yvalues with a range of 14500.0 to 16500.0) may be determined (e.g., the scenario evaluation datastructure with identifier ID_evaluator_67_14500_16500).

A scenario result value for the updated scenario parameters values may be calculated at 289. In one embodiment, an evaluation function specified by the determined surface datastructure and/or scenario evaluation datastructure (e.g., via a coefficients datastructure) may be utilized to calculate the scenario result value for the updated scenario parameters values. In one implementation, the updated scenario parameters values (e.g., with retirement age of 67 as an x value and contributions of 15600 as a y value) may be evaluated by the evaluation function to determine the scenario result value (e.g., annual withdrawal amount as a z value). For example, the scenario result value for the updated scenario parameters values may be calculated as follows:

Scenario Result Value Calculation

```
Coefficients datastructure specified by ID_evaluator_67_14500_16500:
  “coefficients”: {
    “constant”: −251480.3076386144,
    “xyCoefficient”: 1.0265901395673265E−14,
    “xcoefficient”: 4344.189575331191,
    “ycoefficient”: 4.086245338347284
  }
```

### Evaluation Function:

$$z = constant + x * xcoefficient + y * ycoefficient + x * y * xyCoefficent \\ z = - 251480.3076386144 + 67 * 434 \; 4.189 \; 575331191 + 15600 * 4.086245338347284 + 67 * 15600 * 1.0265901395673265 E - 14 \\ z = 10332 \; 5.8211 \; 86804$$

A system progression simulation update response may be generated at 293. In one embodiment, the system progression simulation update response may comprise a system progression simulation result (e.g., retirement analysis) for the updated scenario parameters values based on the system progression simulation and/or the scenario result value. For example, the system progression simulation result may specify a result amount (e.g., a monthly withdrawal amount determined as the annual withdrawal amount divided by 12) for the updated scenario parameters values. In another example, the system progression simulation result may specify a result score (e.g., determined as a percentage of monthly expenses covered by the monthly withdrawal amount) for the updated scenario parameters values. In one implementation, the system progression simulation update response may be provided to the user via a system progression simulation update output.

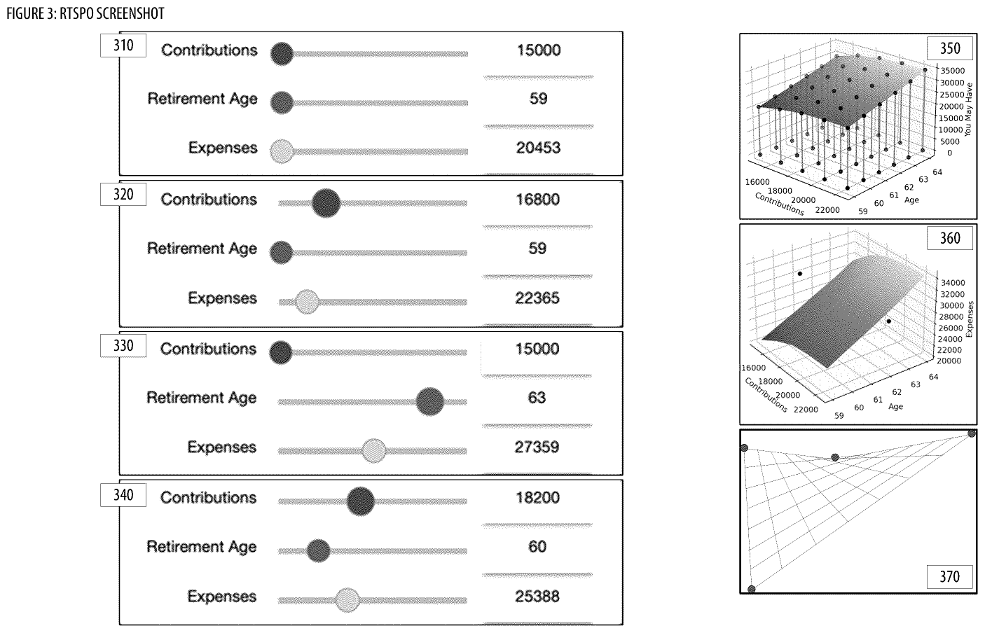

FIG. 3 shows non-limiting, example embodiments of a screenshot illustrating user interface(s) of the RTSPO. In FIG. 3, an exemplary user interface (e.g., for a mobile device, for a website) to facilitate a user's real-time interaction with a system progression simulation (e.g., retirement plan simulation) is illustrated. Screen 310 shows initial scenario parameters values (e.g., retirement age of 59, contributions of 15000 per year) specified by the user and a corresponding scenario result value (e.g., withdrawals cover 20453 of expenses per year). Screen 320 shows updated scenario parameters values (e.g., retirement age of 59, contributions of 16800 per year) specified by the user (e.g., via a contributions slider) and an updated (e.g., in real time) scenario result value (e.g., withdrawals cover 22365 of expenses per year). Screen 330 shows updated scenario parameters values (e.g., retirement age of 63, contributions of 15000 per year) specified by the user (e.g., via a retirement age slider) and an updated (e.g., in real time) scenario result value (e.g., withdrawals cover 27359 of expenses per year). Screen 340 shows updated scenario parameters values (e.g., retirement age of 60, contributions of 18200 per year) specified by the user (e.g., via a contributions slider and via a retirement age slider) and an updated (e.g., in real time) scenario result value (e.g., withdrawals cover 25388 of expenses per year). In one embodiment, surface mapping graphs, such as those shown in screens 350, 360, 370, may be shown interactively responding in real-time to manipulations of each slider user interface element of the exemplary user interface.

In some embodiments, the user may specify a desired level of expenses to be covered by withdrawals (e.g., via an expenses slider) and the RTSPO may adjust scenario parameters values (e.g., via a contributions slider and/or via a retirement age slider) and/or show the user viable alternatives for adjusting scenario parameters values (e.g., +1 retirement age, +400 monthly contributions OR +2 retirement age, +220 monthly contributions) to satisfy the desired level of expenses to be covered by the withdrawals. In one implementation, generated surface datastructure(s) (e.g., as discussed with regard to FIG. 2) may be parsed (e.g., using PHP commands) to determine matching surface datastructure(s) (e.g., surface datastructure(s) and/or a scenario evaluation datastructure(s) whose zvalues range includes the desired level of expenses to be covered by the withdrawals) to determine the viable alternatives.

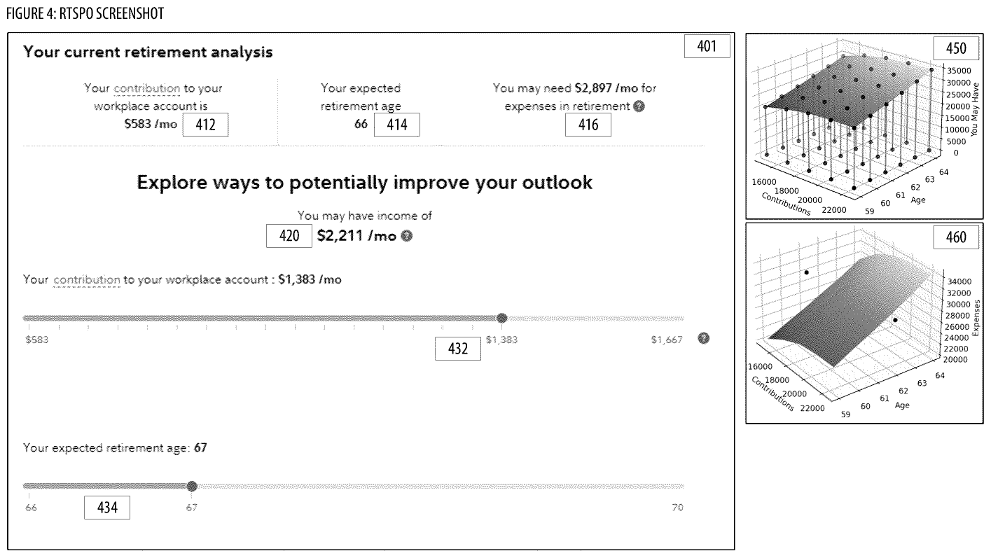

FIG. 4 shows non-limiting, example embodiments of a screenshot illustrating user interface(s) of the RTSPO. In FIG. 4, an exemplary user interface (e.g., for a mobile device, for a website) to facilitate a user's real-time interaction with a system progression simulation (e.g., retirement plan simulation) is illustrated. Screen 401 shows initial scenario parameters values (e.g., contributions of 583 per month as shown at 412, and retirement age of 66 as shown at 414) specified by the user and expenses to be covered by the withdrawals (e.g., 2897 per month as shown at 416). Screen 401 also shows updated scenario parameters values (e.g., contributions of 1383 per month as shown at 432, and retirement age of 67 as shown at 434) specified by the user (e.g., via a contributions slider and via a retirement age slider) and an updated (e.g., in real time) scenario result value (e.g., withdrawals of 2211 per month as shown at 420, corresponding to a result score of 76.32%). In one embodiment, surface mapping graphs, such as those shown in screens 450, 460, may be shown interactively responding in real-time to manipulations of each slider user interface element of the exemplary user interface.

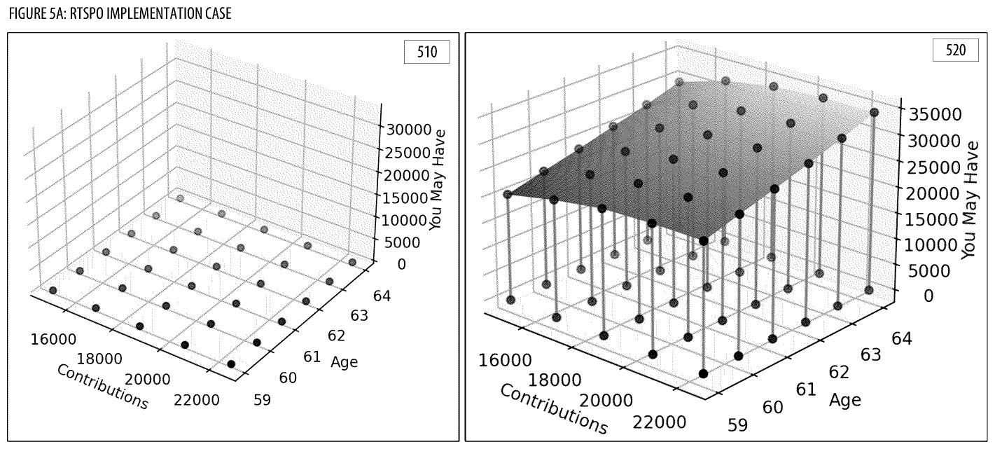

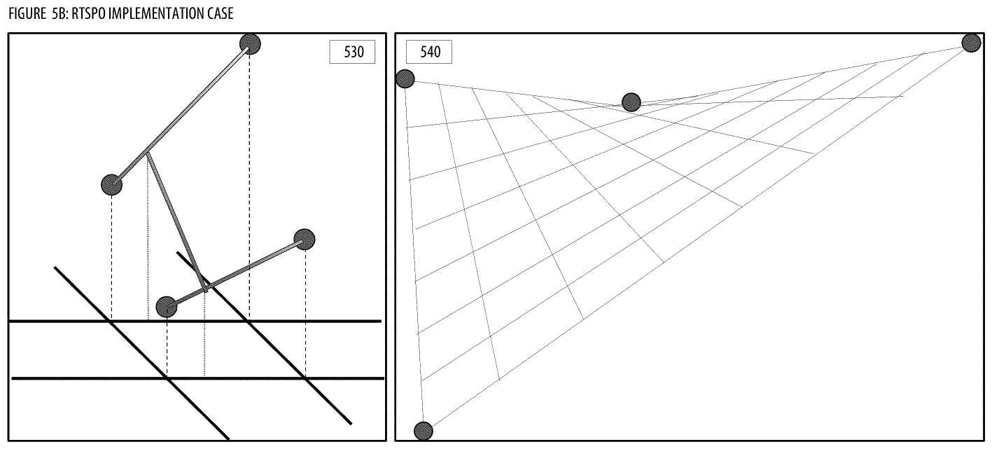

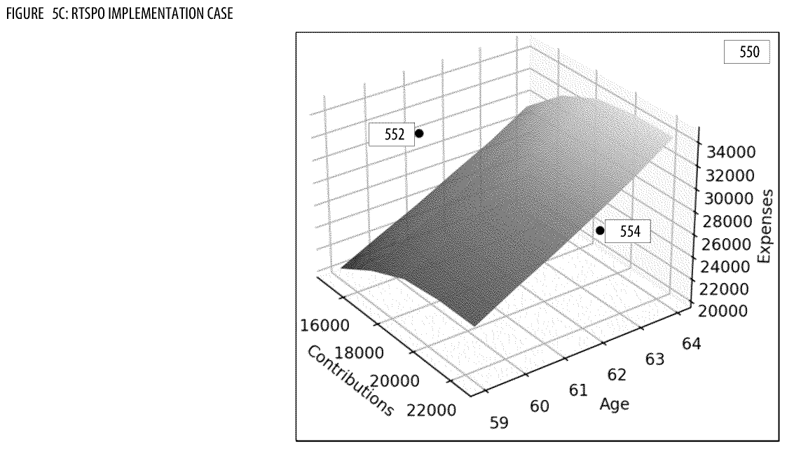

FIGS. 5A-5C show non-limiting, example embodiments of implementation case(s) for the RTSPO. In FIGS. 5A-5C, an exemplary implementation case to generate a surface for a system progression simulation request of a user is illustrated. Screen 510 shows scenario evaluation points associated with the system progression simulation request. In one implementation, the scenario evaluation points may be equally spaced points along a specified interval on each axis. For example, values between retirement age−2 and retirement age+5 may be used as the specified interval for retirement age axis. In another example, values between the user's current contributions level (e.g., 14500) and a maximum allowed level (e.g., 22500 per year) may be used as the specified interval for contributions axis. Screen 520 shows a 6 by 5 grid, of scenario result values determined via a scenario solver at the scenario evaluation points. The grid also shows quadratic surfaces connecting 4 points of each rectangle in the grid, which combined form a desired surface via a bilinear interpolating spline. Screen 530) shows that an evaluation function may be generated via bilinear interpolation (e.g., for fixed x, z-values are linear in y). Screen 540 shows a quadratic surface connecting 4 points of a rectangle in the grid. Such a surface may be fast to create and/or to evaluate at new points. Screen 550 shows that the generated surface may be used to determine what level of expenses may be covered by withdrawals. Any point above the surface, such as point 552, is not achievable, and any point at or below the surface, such as point 554, is achievable.

### Additional Alternative Embodiment Examples

The following alternative example embodiments provide a number of variations of some of the already discussed principles for expanded color on the abilities of the RTSPO.

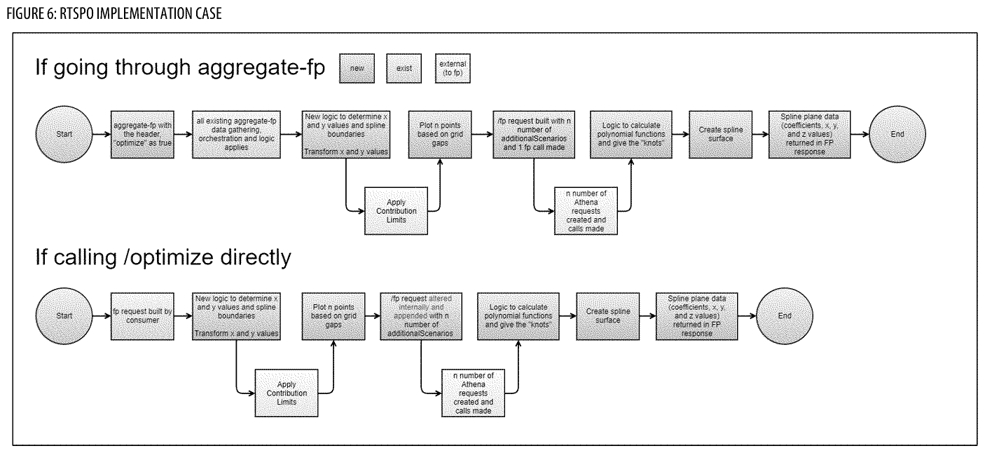

FIG. 6 shows non-limiting, example embodiments of implementation case(s) for the RTSPO. In FIG. 6, exemplary implementation cases to generate a surface for a system progression simulation are illustrated. In one implementation, aggregate-fp component may be called to gather a user's profiles. In another implementation,/optimize component may be called directly when a user's profiles data is already specified.

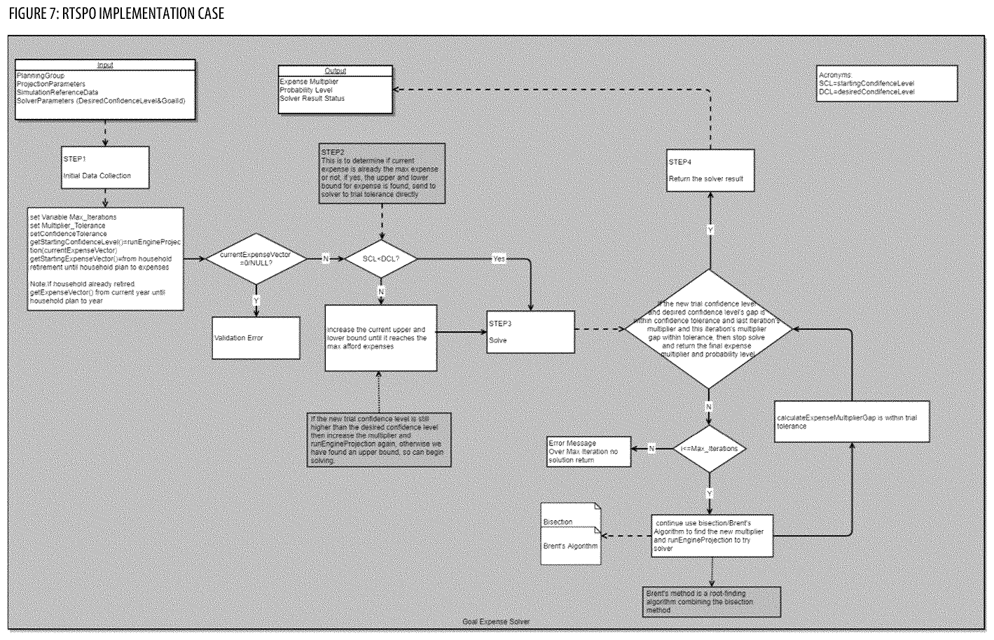

FIG. 7 shows non-limiting, example embodiments of implementation case(s) for the RTSPO. In FIG. 7, an exemplary logic flow to facilitate implementation of a scenario solver (e.g., Athena goal-expense solver) is illustrated.

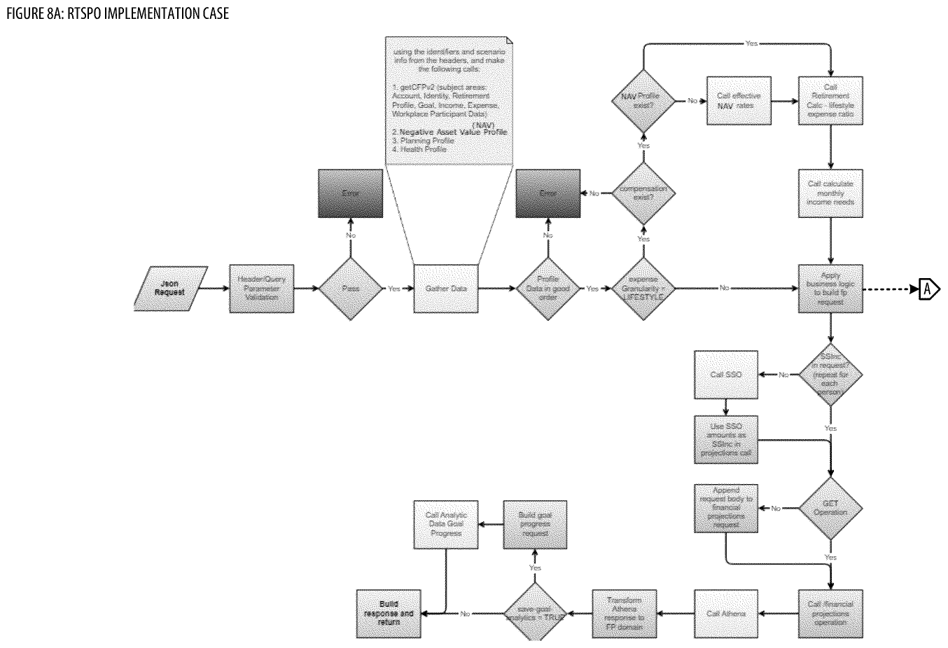

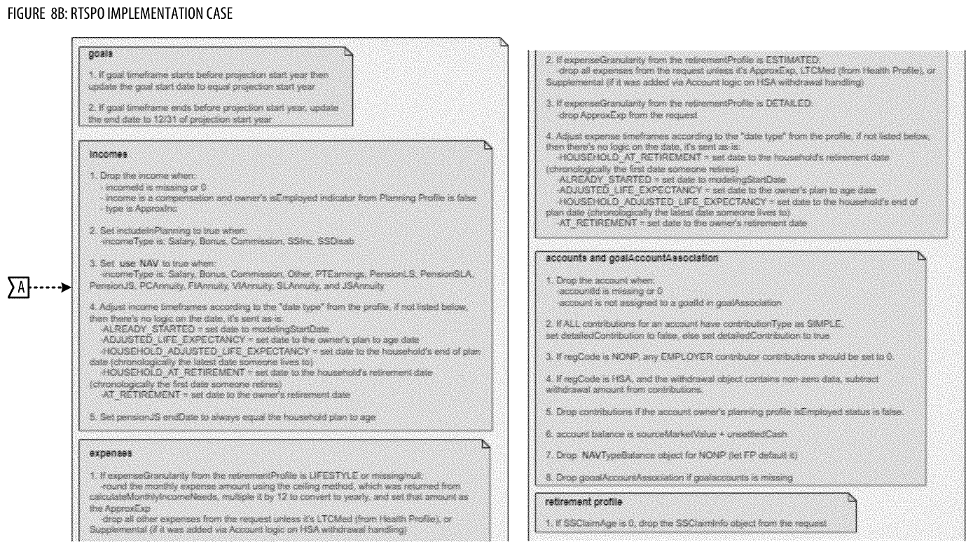

FIGS. 8A-8B show non-limiting, example embodiments of implementation case(s) for the RTSPO. In FIGS. 8A-8B, an exemplary logic flow to facilitate implementation of aggregate-fp component is illustrated.

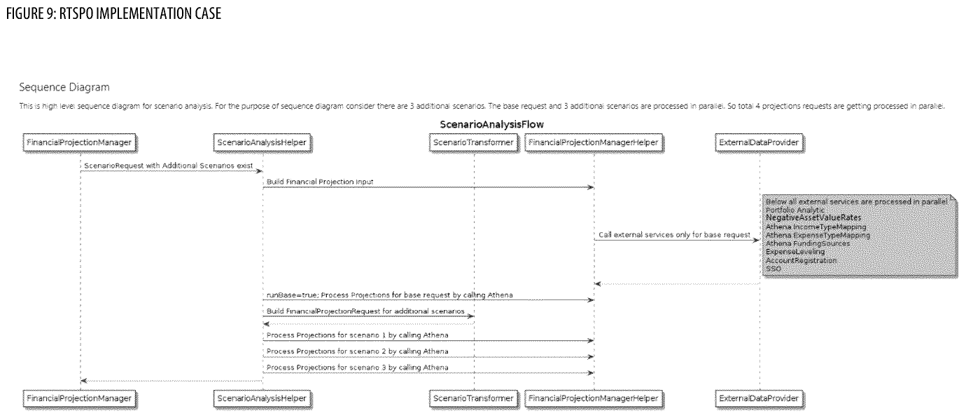

FIG. 9 shows non-limiting, example embodiments of implementation case(s) for the RTSPO. In FIG. 9, an exemplary data flow to facilitate implementation of a scenario analysis service is illustrated. For example, each scenario may comprise a slight change to a user profile (e.g., to retirement age and contribution amount).

Additional embodiments may include:
1. A real-time system progression simulation interaction apparatus, comprising:
at least one memory;
a component collection stored in the at least one memory;
at least one processor disposed in communication with the at least one memory, the at least one processor executing processor-executable instructions from the component collection, the component collection storage structured with processor-executable instructions, comprising:
   obtain, via the at least one processor, a system progression simulation request datastructure structured as specifying a set of initial scenario parameters values for a set of scenario parameters;
   determine, via the at least one processor, for each respective scenario parameter in the set of scenario parameters, a set of parameter evaluation values for the respective scenario parameter, in which each parameter evaluation value in the set of parameter evaluation values for the respective scenario parameter is within an interval specified by a set of boundary values for the respective scenario parameter;
   determine, via the at least one processor, a set of scenario evaluation points, in which each scenario evaluation point in the set of scenario evaluation points is structured as an intersection of parameter evaluation values from each of the determined sets of parameter evaluation values;
   compute, via the at least one processor, for each respective scenario evaluation point in the set of scenario evaluation points, a scenario result value for the respective scenario evaluation point via a system progression simulation;
   determine, via the at least one processor, a set of surface descriptor datastructures, in which each surface descriptor datastructure in the set of surface descriptor datastructures is structured as specifying a set of surface points defining a surface;
   generate, via the at least one processor, for each respective surface descriptor datastructure in the set of surface descriptor datastructures, a scenario evaluation datastructure structured as specifying an evaluation function determined via interpolation on a set of surface points specified by the respective surface descriptor datastructure;
   determine, via the at least one processor, a first generated scenario evaluation datastructure matching the set of initial scenario parameters values; and
   determine, via the at least one processor, a scenario result value for the set of initial scenario parameters values via an evaluation function specified by the first matching scenario evaluation datastructure.
2. The apparatus of embodiment 1, in which a set of boundary values for a scenario parameter comprises a minimum value and a maximum value.
3. The apparatus of embodiment 1, in which a set of boundary values for a scenario parameter is determined via a set of default values.
4. The apparatus of embodiment 1, in which a set of boundary values for a scenario parameter is determined via a calculation that utilizes an initial scenario parameters value corresponding to the scenario parameter.
5. The apparatus of embodiment 1, in which a set of parameter evaluation values for a scenario parameter comprises equally spaced points along the interval associated with the scenario parameter.
6. The apparatus of embodiment 1, in which the system progression simulation is structured as computing a scenario result value for a scenario evaluation point via a calculation that utilizes parameter evaluation values specified by the scenario evaluation point.
7. The apparatus of embodiment 1, in which scenario result values for the set of scenario evaluation points are computed in parallel.
8. The apparatus of embodiment 1, in which a surface point specified by a surface descriptor datastructure comprises parameter evaluation values of a corresponding scenario evaluation point and a computed scenario result value for the corresponding scenario evaluation point.
9. The apparatus of embodiment 1, in which the surface is a quadratic surface.
10. The apparatus of embodiment 1, in which a scenario evaluation datastructure comprises a coefficients datastructure structured as specifying coefficients of a bilinear function.
11. The apparatus of embodiment 1, in which the component collection storage is further structured with processor-executable instructions, comprising:
   generate, via the at least one processor, a system progression simulation response datastructure structured as specifying a result value determined via a calculation that utilizes the scenario result value for the set of initial scenario parameters values.
12. The apparatus of embodiment 11, in which the system progression simulation request datastructure is structured as specifying a goal value, and in which the system progression simulation response datastructure is structured as specifying a result score determined via a calculation that utilizes the scenario result value for the set of initial scenario parameters values and the goal value.
13. The apparatus of embodiment 1, in which the component collection storage is further structured with processor-executable instructions, comprising:
   obtain, via the at least one processor, a system progression simulation update request datastructure structured as specifying a set of updated scenario parameters values for the set of scenario parameters;
   determine, via the at least one processor, a second generated scenario evaluation datastructure matching the set of updated scenario parameters values; and
   determine, via the at least one processor, a scenario result value for the set of updated scenario parameters values via an evaluation function specified by the second matching scenario evaluation datastructure.
14. The apparatus of embodiment 13, in which the component collection storage is further structured with processor-executable instructions, comprising:
   generate, via the at least one processor, a system progression simulation update response datastructure structured as specifying a result value determined via a calculation that utilizes the scenario result value for the set of updated scenario parameters values.
15. The apparatus of embodiment 13, in which the first generated scenario evaluation datastructure and the second generated scenario evaluation datastructure are identical.
16. A real-time system progression simulation interaction processor-readable, non-transient medium, the medium storing a component collection, the component collection storage structured with processor-executable instructions comprising:
   obtain, via the at least one processor, a system progression simulation request datastructure structured as specifying a set of initial scenario parameters values for a set of scenario parameters;
   determine, via the at least one processor, for each respective scenario parameter in the set of scenario parameters, a set of parameter evaluation values for the respective scenario parameter, in which each parameter evaluation value in the set of parameter evaluation values for the respective scenario parameter is within an interval specified by a set of boundary values for the respective scenario parameter;
   determine, via the at least one processor, a set of scenario evaluation points, in which each scenario evaluation point in the set of scenario evaluation points is structured as an intersection of parameter evaluation values from each of the determined sets of parameter evaluation values;
   compute, via the at least one processor, for each respective scenario evaluation point in the set of scenario evaluation points, a scenario result value for the respective scenario evaluation point via a system progression simulation;
   determine, via the at least one processor, a set of surface descriptor datastructures, in which each surface descriptor datastructure in the set of surface descriptor datastructures is structured as specifying a set of surface points defining a surface;
   generate, via the at least one processor, for each respective surface descriptor datastructure in the set of surface descriptor datastructures, a scenario evaluation datastructure structured as specifying an evaluation function determined via interpolation on a set of surface points specified by the respective surface descriptor datastructure;
   determine, via the at least one processor, a first generated scenario evaluation datastructure matching the set of initial scenario parameters values; and
   determine, via the at least one processor, a scenario result value for the set of initial scenario parameters values via an evaluation function specified by the first matching scenario evaluation datastructure.
17. The medium of embodiment 16, in which a set of boundary values for a scenario parameter comprises a minimum value and a maximum value.
18. The medium of embodiment 16, in which a set of boundary values for a scenario parameter is determined via a set of default values.
19. The medium of embodiment 16, in which a set of boundary values for a scenario parameter is determined via a calculation that utilizes an initial scenario parameters value corresponding to the scenario parameter.
20. The medium of embodiment 16, in which a set of parameter evaluation values for a scenario parameter comprises equally spaced points along the interval associated with the scenario parameter.
21. The medium of embodiment 16, in which the system progression simulation is structured as computing a scenario result value for a scenario evaluation point via a calculation that utilizes parameter evaluation values specified by the scenario evaluation point.
22. The medium of embodiment 16, in which scenario result values for the set of scenario evaluation points are computed in parallel.
23. The medium of embodiment 16, in which a surface point specified by a surface descriptor datastructure comprises parameter evaluation values of a corresponding scenario evaluation point and a computed scenario result value for the corresponding scenario evaluation point.
24. The medium of embodiment 16, in which the surface is a quadratic surface.
25. The medium of embodiment 16, in which a scenario evaluation datastructure comprises a coefficients datastructure structured as specifying coefficients of a bilinear function.
26. The medium of embodiment 16, in which the component collection storage is further structured with processor-executable instructions, comprising:
   generate, via the at least one processor, a system progression simulation response datastructure structured as specifying a result value determined via a calculation that utilizes the scenario result value for the set of initial scenario parameters values.
27. The medium of embodiment 26, in which the system progression simulation request datastructure is structured as specifying a goal value, and in which the system progression simulation response datastructure is structured as specifying a result score determined via a calculation that utilizes the scenario result value for the set of initial scenario parameters values and the goal value.
28. The medium of embodiment 16, in which the component collection storage is further structured with processor-executable instructions, comprising:
   obtain, via the at least one processor, a system progression simulation update request datastructure structured as specifying a set of updated scenario parameters values for the set of scenario parameters;
   determine, via the at least one processor, a second generated scenario evaluation datastructure matching the set of updated scenario parameters values; and
   determine, via the at least one processor, a scenario result value for the set of updated scenario parameters values via an evaluation function specified by the second matching scenario evaluation datastructure.
29. The medium of embodiment 28, in which the component collection storage is further structured with processor-executable instructions, comprising:
   generate, via the at least one processor, a system progression simulation update response datastructure structured as specifying a result value determined via a calculation that utilizes the scenario result value for the set of updated scenario parameters values.
30. The medium of embodiment 28, in which the first generated scenario evaluation datastructure and the second generated scenario evaluation datastructure are identical.
31. A real-time system progression simulation interaction processor-implemented system, comprising: means to store a component collection;
means to process processor-executable instructions from the component collection, the component collection storage structured with processor-executable instructions including:
   obtain, via the at least one processor, a system progression simulation request datastructure structured as specifying a set of initial scenario parameters values for a set of scenario parameters;
   determine, via the at least one processor, for each respective scenario parameter in the set of scenario parameters, a set of parameter evaluation values for the respective scenario parameter, in which each parameter evaluation value in the set of parameter evaluation values for the respective scenario parameter is within an interval specified by a set of boundary values for the respective scenario parameter;
   determine, via the at least one processor, a set of scenario evaluation points, in which each scenario evaluation point in the set of scenario evaluation points is structured as an intersection of parameter evaluation values from each of the determined sets of parameter evaluation values;
   compute, via the at least one processor, for each respective scenario evaluation point in the set of scenario evaluation points, a scenario result value for the respective scenario evaluation point via a system progression simulation;
   determine, via the at least one processor, a set of surface descriptor datastructures, in which each surface descriptor datastructure in the set of surface descriptor datastructures is structured as specifying a set of surface points defining a surface;
   generate, via the at least one processor, for each respective surface descriptor datastructure in the set of surface descriptor datastructures, a scenario evaluation datastructure structured as specifying an evaluation function determined via interpolation on a set of surface points specified by the respective surface descriptor datastructure;
   determine, via the at least one processor, a first generated scenario evaluation datastructure matching the set of initial scenario parameters values; and
   determine, via the at least one processor, a scenario result value for the set of initial scenario parameters values via an evaluation function specified by the first matching scenario evaluation datastructure.
32. The system of embodiment 31, in which a set of boundary values for a scenario parameter comprises a minimum value and a maximum value.
33. The system of embodiment 31, in which a set of boundary values for a scenario parameter is determined via a set of default values.
34. The system of embodiment 31, in which a set of boundary values for a scenario parameter is determined via a calculation that utilizes an initial scenario parameters value corresponding to the scenario parameter.
35. The system of embodiment 31, in which a set of parameter evaluation values for a scenario parameter comprises equally spaced points along the interval associated with the scenario parameter.
36. The system of embodiment 31, in which the system progression simulation is structured as computing a scenario result value for a scenario evaluation point via a calculation that utilizes parameter evaluation values specified by the scenario evaluation point.
37. The system of embodiment 31, in which scenario result values for the set of scenario evaluation points are computed in parallel.
38. The system of embodiment 31, in which a surface point specified by a surface descriptor datastructure comprises parameter evaluation values of a corresponding scenario evaluation point and a computed scenario result value for the corresponding scenario evaluation point.
39. The system of embodiment 31, in which the surface is a quadratic surface.
40. The system of embodiment 31, in which a scenario evaluation datastructure comprises a coefficients datastructure structured as specifying coefficients of a bilinear function.
41. The system of embodiment 31, in which the component collection storage is further structured with processor-executable instructions, comprising:
   generate, via the at least one processor, a system progression simulation response datastructure structured as specifying a result value determined via a calculation that utilizes the scenario result value for the set of initial scenario parameters values.
42. The system of embodiment 41, in which the system progression simulation request datastructure is structured as specifying a goal value, and in which the system progression simulation response datastructure is structured as specifying a result score determined via a calculation that utilizes the scenario result value for the set of initial scenario parameters values and the goal value.
43. The system of embodiment 31, in which the component collection storage is further structured with processor-executable instructions, comprising:
   obtain, via the at least one processor, a system progression simulation update request datastructure structured as specifying a set of updated scenario parameters values for the set of scenario parameters;
   determine, via the at least one processor, a second generated scenario evaluation datastructure matching the set of updated scenario parameters values; and
   determine, via the at least one processor, a scenario result value for the set of updated scenario parameters values via an evaluation function specified by the second matching scenario evaluation datastructure.
44. The system of embodiment 43, in which the component collection storage is further structured with processor-executable instructions, comprising:
   generate, via the at least one processor, a system progression simulation update response datastructure structured as specifying a result value determined via a calculation that utilizes the scenario result value for the set of updated scenario parameters values.
45. The system of embodiment 43, in which the first generated scenario evaluation datastructure and the second generated scenario evaluation datastructure are identical.
46. A real-time system progression simulation interaction processor-implemented process, including processing processor-executable instructions via at least one processor from a component collection stored in at least one memory, the component collection storage structured with processor-executable instructions comprising:
   obtain, via the at least one processor, a system progression simulation request datastructure structured as specifying a set of initial scenario parameters values for a set of scenario parameters;
   determine, via the at least one processor, for each respective scenario parameter in the set of scenario parameters, a set of parameter evaluation values for the respective scenario parameter, in which each parameter evaluation value in the set of parameter evaluation values for the respective scenario parameter is within an interval specified by a set of boundary values for the respective scenario parameter;
   determine, via the at least one processor, a set of scenario evaluation points, in which each scenario evaluation point in the set of scenario evaluation points is structured as an intersection of parameter evaluation values from each of the determined sets of parameter evaluation values;
   compute, via the at least one processor, for each respective scenario evaluation point in the set of scenario evaluation points, a scenario result value for the respective scenario evaluation point via a system progression simulation;
   determine, via the at least one processor, a set of surface descriptor datastructures, in which each surface descriptor datastructure in the set of surface descriptor datastructures is structured as specifying a set of surface points defining a surface;
   generate, via the at least one processor, for each respective surface descriptor datastructure in the set of surface descriptor datastructures, a scenario evaluation datastructure structured as specifying an evaluation function determined via interpolation on a set of surface points specified by the respective surface descriptor datastructure;
   determine, via the at least one processor, a first generated scenario evaluation datastructure matching the set of initial scenario parameters values; and
   determine, via the at least one processor, a scenario result value for the set of initial scenario parameters values via an evaluation function specified by the first matching scenario evaluation datastructure.
47. The process of embodiment 46, in which a set of boundary values for a scenario parameter comprises a minimum value and a maximum value.
48. The process of embodiment 46, in which a set of boundary values for a scenario parameter is determined via a set of default values.
49. The process of embodiment 46, in which a set of boundary values for a scenario parameter is determined via a calculation that utilizes an initial scenario parameters value corresponding to the scenario parameter.
50. The process of embodiment 46, in which a set of parameter evaluation values for a scenario parameter comprises equally spaced points along the interval associated with the scenario parameter.
51. The process of embodiment 46, in which the system progression simulation is structured as computing a scenario result value for a scenario evaluation point via a calculation that utilizes parameter evaluation values specified by the scenario evaluation point.
52. The process of embodiment 46, in which scenario result values for the set of scenario evaluation points are computed in parallel.
53. The process of embodiment 46, in which a surface point specified by a surface descriptor datastructure comprises parameter evaluation values of a corresponding scenario evaluation point and a computed scenario result value for the corresponding scenario evaluation point.
54. The process of embodiment 46, in which the surface is a quadratic surface.
55. The process of embodiment 46, in which a scenario evaluation datastructure comprises a coefficients datastructure structured as specifying coefficients of a bilinear function.
56. The process of embodiment 46, in which the component collection storage is further structured with processor-executable instructions, comprising:
   generate, via the at least one processor, a system progression simulation response datastructure structured as specifying a result value determined via a calculation that utilizes the scenario result value for the set of initial scenario parameters values.
57. The process of embodiment 56, in which the system progression simulation request datastructure is structured as specifying a goal value, and in which the system progression simulation response datastructure is structured as specifying a result score determined via a calculation that utilizes the scenario result value for the set of initial scenario parameters values and the goal value.
58. The process of embodiment 46, in which the component collection storage is further structured with processor-executable instructions, comprising:
   obtain, via the at least one processor, a system progression simulation update request datastructure structured as specifying a set of updated scenario parameters values for the set of scenario parameters;
   determine, via the at least one processor, a second generated scenario evaluation datastructure matching the set of updated scenario parameters values; and
   determine, via the at least one processor, a scenario result value for the set of updated scenario parameters values via an evaluation function specified by the second matching scenario evaluation datastructure.
59. The process of embodiment 58, in which the component collection storage is further structured with processor-executable instructions, comprising:
   generate, via the at least one processor, a system progression simulation update response datastructure structured as specifying a result value determined via a calculation that utilizes the scenario result value for the set of updated scenario parameters values.
60. The process of embodiment 58, in which the first generated scenario evaluation datastructure and the second generated scenario evaluation datastructure are identical.

### RTSPO Controller

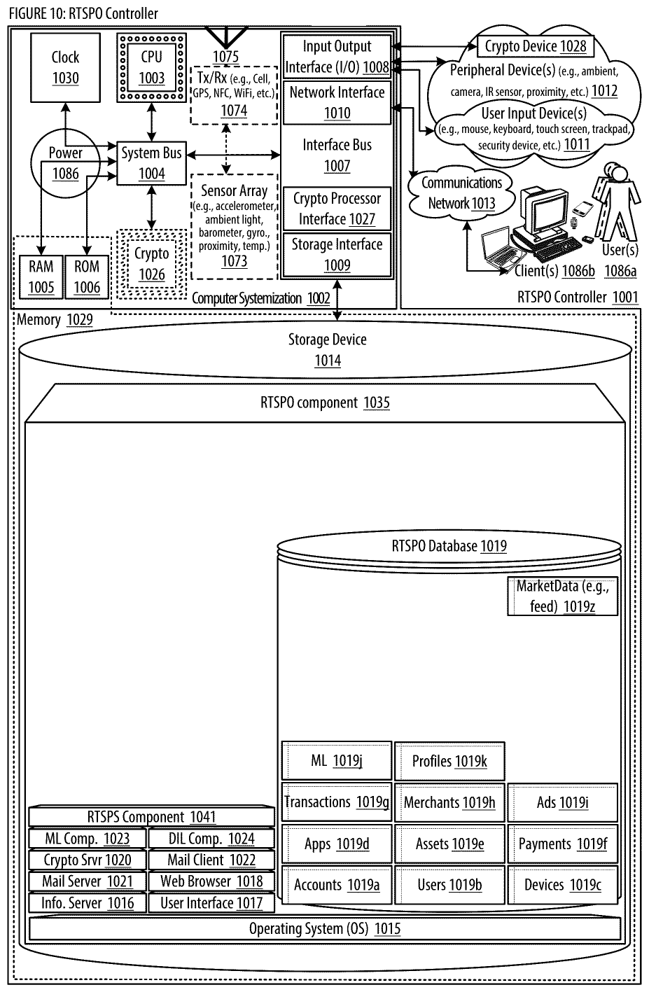

FIG. 10 shows a block diagram illustrating non-limiting, example embodiments of a RTSPO controller. In this embodiment, the RTSPO controller 1001 may serve to aggregate, process, store, search, serve, identify, instruct, generate, match, and/or facilitate interactions with a computer through information technology technologies, and/or other related data.

Users, which may be people and/or other systems, may engage information technology systems (e.g., computers) to facilitate information processing. In turn, computers employ processors to process information; such processors 1003 may be referred to as central processing units (CPU). One form of processor is referred to as a microprocessor. CPUs use communicative circuits to pass binary encoded signals acting as instructions to allow various operations. These instructions may be operational and/or data instructions containing and/or referencing other instructions and data in various processor accessible and operable areas of memory 1029 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the RTSPO controller 1001 may be connected to and/or communicate with entities such as, but not limited to: one or more users from peripheral devices 1012 (e.g., user input devices 1011); an optional cryptographic processor device 1028; and/or a communications network 1013.

Networks comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is referred to as a “node.” Networks are generally thought to facilitate the transfer of information from source points to destinations. A node specifically tasked with furthering the passage of information from a source to a destination is called a “router.” There are many forms of networks such as Local Area Networks (LANs), Pico networks, Wide Area Networks (WANs), Wireless Networks (WLANs), etc. For example, the Internet is, generally, an interconnection of a multitude of networks whereby remote clients and servers may access and interoperate with one another.

The RTSPO controller 1001 may be based on computer systems that may comprise, but are not limited to, components such as: a computer systemization 1002 connected to memory 1029.

### Computer Systemization

A computer systemization 1002 may comprise a clock 1030, central processing unit (“CPU(s)” and/or “processor(s)” (these terms are used interchangeably throughout the disclosure unless noted to the contrary)) 1003, a memory 1029 (e.g., a read only memory (ROM) 1006, a random access memory (RAM) 1005, etc.), and/or an interface bus 1007, and most frequently, although not necessarily, are all interconnected and/or communicating through a system bus 1004 on one or more (mother) board(s) 1002 having conductive and/or otherwise transportive circuit pathways through which instructions (e.g., binary encoded signals) may travel to effectuate communications, operations, storage, etc. The computer systemization may be connected to a power source 1086; e.g., optionally the power source may be internal. Optionally, a cryptographic processor 1026 may be connected to the system bus. In another embodiment, the cryptographic processor, transceivers (e.g., ICs) 1074, and/or sensor array (e.g., accelerometer, altimeter, ambient light, barometer, global positioning system (GPS) (thereby allowing RTSPO controller to determine its location), gyroscope, magnetometer, pedometer, proximity, ultra-violet sensor, etc.) 1073 may be connected as either internal and/or external peripheral devices 1012 via the interface bus I/O 1008 (not pictured) and/or directly via the interface bus 1007. In turn, the transceivers may be connected to antenna(s) 1075, thereby effectuating wireless transmission and reception of various communication and/or sensor protocols; for example the antenna(s) may connect to various transceiver chipsets (depending g on deployment needs), including: Broadcom® BCM4329FKUBG transceiver chip (e.g., providing 802.11n, Bluetooth 2.1+EDR, FM, etc.); a Broadcom® BCM4752 GPS receiver with accelerometer, altimeter, GPS, gyroscope, magnetometer; a Broadcom® BCM4335 transceiver chip (e.g., providing 2G, 3G, and 4G long-term evolution (LTE) cellular communications; 802.11ac, Bluetooth 4.0 low energy (LE) (e.g., beacon features)); a Broadcom® BCM43341 transceiver chip (e.g., providing 2G, 3G and 4G LTE cellular communications; 802.11g/, Bluetooth 4.0, near field communication (NFC), FM radio); an Infineon Technologies® X-Gold 618-PMB9800 transceiver chip (e.g., providing 2G/3G HSDPA/HSUPA communications); a MediaTek® MT6620 transceiver chip (e.g., providing 802.11a/ac/b/g/n (also known as WiFi in numerous iterations), Bluetooth 4.0 LE, FM, GPS; a Lapis Semiconductor® ML.8511 UV sensor; a maxim integrated MAX44000 ambient light and infrared proximity sensor; a Texas Instruments® WiLink WL1283 transceiver chip (e.g., providing 802.11n, Bluetooth 3.0, FM, GPS); and/or the like. The system clock may have a crystal oscillator and generates a base signal through the computer systemization's circuit pathways. The clock may be coupled to the system bus and various clock multipliers that may increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU is often packaged in a number of formats varying from large supercomputer(s) and mainframe(s) computers, down to mini computers, servers, desktop computers, laptops, thin clients (e.g., Chromebooks®), netbooks, tablets (e.g., Android®, iPads®, and Windows® tablets, etc.), mobile smartphones (e.g., Android®, iPhones®, Nokia®, Palm® and Windows® phones, etc.), wearable device(s) (e.g., headsets (e.g., Apple AirPods (Pro)®, glasses, goggles (e.g., Google Glass®), watches, etc.), and/or the like. Often, the processors themselves may incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1029 beyond the processor itself; internal memory may include, but is not limited to: fast registers, various levels of cache memory (e.g., level 1, 2, 3, etc.), (dynamic/static) RAM, solid state memory, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon®, Duron® and/or Opteron®; Apple's® A series of processors (e.g., A5, A6, A7, A8, etc.); ARM's® application, embedded and secure processors; IBM® and/or Motorola's DragonBall® and PowerPC®; IBM's® and Sony's® Cell processor; Intel's® 80X86 series (e.g., 80386, 80486), Pentium®, Celeron®, Core (2) Duo®, i series (e.g., i3, i5, i7, i9, etc.), Itanium®, Xeon®, and/or XScale®; Motorola's® 680X0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code), e.g., via load/read address commands; e.g., the CPU may read processor issuable instructions from memory (e.g., reading it from a component collection (e.g., an interpreted and/or compiled program application/library including allowing the processor to execute instructions from the application/library) stored in the memory). Such instruction passing facilitates communication within the RTSPO controller and beyond through various interfaces. Should processing requirements dictate a greater amount speed and/or capacity, distributed processors (e.g., see Distributed RTSPO below), mainframe, multi-core, parallel, and/or super-computer architectures may similarly be employed. Alternatively, should deployment requirements dictate greater portability, smaller mobile devices (e.g., Personal Digital Assistants (PDAs)) may be employed.

Depending on the particular implementation, features of the RTSPO may be achieved by implementing a microcontroller such as CAST's® R8051XC2 microcontroller; Diligent's® Basys 3 Artix-7, Nexys A7-100T, U192015125IT, etc.; Intel's® MCS 51 (i.e., 8051 microcontroller); and/or the like. Also, to implement certain features of the RTSPO, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the RTSPO component collection (distributed or otherwise) and/or features may be implemented via the microprocessor and/or via embedded components; e.g., via ASIC, coprocessor, DSP, FPGA, and/or the like. Alternately, some implementations of the RTSPO may be implemented with embedded components that are configured and used to achieve a variety of features or signal processing.

Depending on the particular implementation, the embedded components may include software solutions, hardware solutions, and/or some combination of both hardware/software solutions. For example, RTSPO features discussed herein may be achieved through implementing FPGAs, which are a semiconductor devices containing programmable logic components called “logic blocks”, and programmable interconnects, such as the high performance FPGA Virtex® series and/or the low cost Spartan® series manufactured by Xilinx®. Logic blocks and interconnects can be programmed by the customer or designer, after the FPGA is manufactured, to implement any of the RTSPO features. A hierarchy of programmable interconnects allow logic blocks to be interconnected as needed by the RTSPO system designer/administrator, somewhat like a one-chip programmable breadboard. An FPGA's logic blocks can be programmed to perform the operation of basic logic gates such as AND, and NOR, or more complex combinational operators such as decoders or mathematical operations. In most FPGAs, the logic blocks also include memory elements, which may be circuit flip-flops or more complete blocks of memory. In some circumstances, the RTSPO may be developed on FPGAs and then migrated into a fixed version that more resembles ASIC implementations. Alternate or coordinating implementations may migrate RTSPO controller features to a final ASIC instead of or in addition to FPGAs. Depending on the implementation all of the aforementioned embedded components and microprocessors may be considered the “CPU” and/or “processor” for the RTSPO.

### Power Source

The power source 1086 may be of any various form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1086 is connected to at least one of the interconnected subsequent components of the RTSPO thereby providing an electric current to all subsequent components. In one example, the power source 1086 is connected to the system bus component 1004. In an alternative embodiment, an outside power source 1086 is provided through a connection across the I/O 1008 interface. For example, Ethernet (with power on Ethernet), IEEE 1394, USB and/or the like connections carry both data and power across the connection and is therefore a suitable source of power.

### Interface Adapters

Interface bus(ses) 1007 may accept, connect, and/or communicate to a number of interface adapters, variously although not necessarily in the form of adapter cards, such as but not limited to: input output interfaces (I/O) 1008, storage interfaces 1009, network interfaces 1010, and/or the like. Optionally, cryptographic processor interfaces 1027 similarly may be connected to the interface bus. The interface bus provides for the communications of interface adapters with one another as well as with other components of the computer systemization. Interface adapters are adapted for a compatible interface bus. Interface adapters variously connect to the interface bus via a slot architecture. Various slot architectures may be employed, such as, but not limited to: Accelerated Graphics Port (AGP), Card Bus, (Extended) Industry Standard Architecture ((E) ISA), Micro Channel Architecture (MCA), NuBus, Peripheral Component Interconnect (Extended) (PCI (X)), PCI Express, Personal Computer Memory Card International Association (PCMCIA), and/or the like.

Storage interfaces 1009 may accept, communicate, and/or connect to a number of storage devices such as, but not limited to: (removable) storage devices 1014, removable disc devices, and/or the like. Storage interfaces may employ connection protocols such as, but not limited to: (Ultra) (Serial) Advanced Technology Attachment (Packet Interface) ((Ultra) (Serial) ATA (PI)), (Enhanced) Integrated Drive Electronics ((E) IDE), Institute of Electrical and Electronics Engineers (IEEE) 1394, fiber channel, Non-Volatile Memory (NVMI) Express (NVMe), Small Computer Systems Interface (SCSI), Thunderbolt, Universal Serial Bus (USB), and/or the like.

Network interfaces 1010 may accept, communicate, and/or connect to a communications network 1013. Through a communications network 1013, the RTSPO controller is accessible through remote clients 1033b (e.g., computers with web browsers) by users 1033a. Network interfaces may employ connection protocols such as, but not limited to: direct connect, Ethernet (thick, thin, twisted pair 10/100/1000/10000 Base T, and/or the like), Token Ring, wireless connection such as IEEE 802.11a-x, and/or the like. Should processing requirements dictate a greater amount speed and/or capacity, distributed network controllers (e.g., see Distributed RTSPO below), architectures may similarly be employed to pool, load balance, and/or otherwise decrease/increase the communicative bandwidth required by the RTSPO controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi, Wireless Application Protocol (WAP), I-mode, and/or the like); and/or the like. A network interface may be regarded as a specialized form of an input output interface. Further, multiple network interfaces 1010 may be used to engage with various communications network types 1013. For example, multiple network interfaces may be employed to allow for the communication over broadcast, multicast, and/or unicast networks.

Input Output interfaces (I/O) 1008 may accept, communicate, and/or connect to user, peripheral devices 1012 (e.g., input devices 1011), cryptographic processor devices 1028, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, Thunderbolt/USB-C, VGA, and/or the like; wireless transceivers: 802.11a/ac/b/g/n/x; Bluetooth; cellular (e.g., code division multiple access (CDMA), high speed packet access (HSPA (+)), high-speed downlink packet access (HSDPA), global system for mobile communications (GSM), long term evolution (LTE), WiMax, etc.); and/or the like. One output device may include a video display, which may comprise a Cathode Ray Tube (CRT), Liquid Crystal Display (LCD), Light-Emitting Diode (LED), Organic Light-Emitting Diode (OLED), and/or the like based monitor with an interface (e.g., HDMI circuitry and cable) that accepts signals from a video interface, may be used. The video interface composites information generated by a computer systemization and generates video signals based on the composited information in a video memory frame. Another output device is a television set, which accepts signals from a video interface. The video interface provides the composited video information through a video connection interface that accepts a video display interface (e.g., an RCA composite video connector accepting an RCA composite video cable; a DVI connector accepting a DVI display cable, etc.).

Peripheral devices 1012 may be connected and/or communicate to I/O and/or other facilities of the like such as network interfaces, storage interfaces, directly to the interface bus, system bus, the CPU, and/or the like. Peripheral devices may be external, internal and/or part of the RTSPO controller. Peripheral devices may include: antenna, audio devices (e.g., line-in, line-out, microphone input, speakers, etc.), cameras (e.g., gesture (e.g., Microsoft Kinect) detection, motion detection, still, video, webcam, etc.), dongles (e.g., for copy protection ensuring secure transactions with a digital signature, as connection/format adaptors, and/or the like), external processors (for added capabilities; e.g., crypto devices 528), force-feedback devices (e.g., vibrating motors), infrared (IR) transceiver, network interfaces, printers, scanners, sensors/sensor arrays and peripheral extensions (e.g., ambient light, GPS, gyroscopes, proximity, temperature, etc.), storage devices, transceivers (e.g., cellular, GPS, etc.), video devices (e.g., goggles, monitors, etc.), video sources, visors, and/or the like. Peripheral devices often include types of input devices (e.g., cameras).

User input devices 1011 often are a type of peripheral device 512 (see above) and may include: accelerometers, cameras, card readers, dongles, finger print readers, gloves, graphics tablets, joysticks, keyboards, microphones, mouse (mice), remote controls, security/biometric devices (e.g., facial identifiers, fingerprint reader, iris reader, retina reader, etc.), styluses, touch screens (e.g., capacitive, resistive, etc.), trackballs, trackpads, watches, and/or the like.

It should be noted that although user input devices and peripheral devices may be employed, the RTSPO controller may be embodied as an embedded, dedicated, and/or monitor-less (i.e., headless) device, and access may be provided over a network interface connection.

Cryptographic units such as, but not limited to, microcontrollers, processors 1026, interfaces 1027, and/or devices 1028 may be attached, and/or communicate with the RTSPO controller. A MC68HC16 microcontroller, manufactured by Motorola, Inc.®, may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other specialized cryptographic processors include: Broadcom's® Crypto NetN and other Security Processors; nCipher's® nShield; SafeNet's® Luna PCI (e.g., 7100) series; Semaphore Communications'® 40 MHz Roadrunner 184; Sun's® Cryptographic Accelerators (e.g., Accelerator 6000 PCIe Board, Accelerator 500 Daughtercard); Via Nano® Processor (e.g., L2100, L2200, U2400) line, which is capable of performing 500+MB/s of cryptographic instructions; VISI Technology's® 33 MHz 6868; and/or the like.

### Memory

Generally, any mechanization and/or embodiment allowing a processor to affect the storage and/or retrieval of information is regarded as memory 1029. The storing of information in memory may result in a physical alteration of the memory to have a different physical state that makes the memory a structure with a unique encoding of the memory stored therein. Often, memory is a fungible technology and resource, thus, any number of memory embodiments may be employed in lieu of or in concert with one another. It is to be understood that the RTSPO controller and/or a computer systemization may employ various forms of memory 1029. For example, a computer systemization may be configured to have the operation of on-chip CPU memory (e.g., registers), RAM, ROM, and any other storage devices performed by a paper punch tape or paper punch card mechanism; however, such an embodiment would result in an extremely slow rate of operation. In one configuration, memory 1029 may include ROM 1006, RAM 1005, and a storage device 1014. A storage device 1014 may be any various computer system storage. Storage devices may include: an array of devices (e.g., Redundant Array of Independent Disks (RAID)); a cache memory, a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); RAM drives; register memory (e.g., in a CPU), solid state memory devices (USB memory, solid state drives (SSD), etc.); other processor-readable storage mediums; and/or other devices of the like. Thus, a computer systemization generally employs and makes use of memory.

### Component Collection

The memory 1029 may contain a collection of processor-executable application/library/program and/or database components (e.g., including processor-executable instructions) and/or data such as, but not limited to: operating system component(s) 1015 (operating system); information server component(s) 1016 (information server); user interface component(s) 1017 (user interface); Web browser component(s) 1018 (Web browser); database(s) 1019; mail server component(s) 1021; mail client component(s) 1022; cryptographic server component(s) 1020 (cryptographic server); machine learning component 1023; distributed immutable ledger component 1024; the RTSPO component(s) 1035 (e.g., which may include RTSPS 1041, and/or the like components); and/or the like (i.e., collectively referred to throughout as a “component collection”). These components may be stored and accessed from the storage devices and/or from storage devices accessible through an interface bus. Although unconventional program components such as those in the component collection may be stored in a local storage device 1014, they may also be loaded and/or stored in memory such as: cache, peripheral devices, processor registers, RAM, remote storage facilities through a communications network, ROM, various forms of memory, and/or the like.

### Operating System

The operating system component 1015 is an executable program component facilitating the operation of the RTSPO controller. The operating system may facilitate access of I/O, network interfaces, peripheral devices, storage devices, and/or the like. The operating system may be a highly fault tolerant, scalable, and secure system such as: Apple's Macintosh OS X (Server) and macOS®; AT&T Plan 9®; Be OS®; Blackberry's QNX®; Google's Chrome®; Microsoft's Windows® Jul. 8, 2010; Unix and Unix-like system distributions (such as AT&T's UNIN®; Berkley Software Distribution (BSD)® variations such as FreeBSD®, NetBSD, OpenBSD, and/or the like; Linux distributions such as Red Hat, Ubuntu, and/or the like); and/or the like operating systems. However, more limited and/or less secure operating systems also may be employed such as Apple Macintosh OS® (i.e., versions 1-9), IBM OS/2®, Microsoft DOS®, Microsoft Windows 2000/2003/3.1/95/98/CE/Millennium/Mobile/NT/Vista/XP/7/X (Server)®, Palm OS®, and/or the like. Additionally, for robust mobile deployment applications, mobile operating systems may be used, such as: Apple's iOS®; China Operating System COS®; Google's Android®; Microsoft Windows RT/Phone®; Palm's WebOS®; Samsung/Intel's Tizen®; and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may facilitate the interaction with communications networks, data, I/O, peripheral devices, program components, memory, user input devices, and/or the like. The operating system may provide communications protocols that allow the RTSPO controller to communicate with other entities through a communications network 1013. Various communication protocols may be used by the RTSPO controller as a subcarrier transport mechanism for interaction, such as, but not limited to: multicast, TCP/IP, UDP, unicast, and/or the like.

### Information Server

An information server component 1016 is a stored program component that is executed by a CPU. The information server may be an Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, Ruby, wireless application protocol (WAP), WebObjects®, and/or the like. The information server may support secure communications protocols such as, but not limited to, File Transfer Protocol (FTP(S)); Hyper Text Transfer Protocol (HTTP); Secure Hypertext Transfer Protocol (HTTPS), Secure Socket Layer (SSL) Transport Layer Security (TLS), messaging protocols (e.g., America Online (AOL) Instant Messenger (AIM)®, Application Exchange (APEX), ICQ, Internet Relay Chat (IRC), Microsoft Network (MSN) Messenger® Service, Presence and Instant Messaging Protocol (PRIM), Internet Engineering Task Force's® (IETF's) Session Initiation Protocol (SIP), SIP for Instant Messaging and Presence Leveraging Extensions (SIMPLE), Slack®, open XML-based Extensible Messaging and Presence Protocol (XMPP) (i.e., Jabber® or Open Mobile Alliance's (OMA's) Instant Messaging and Presence Service (IMPS)), Yahoo! Instant Messenger® Service, and/or the like). The information server may provide results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the RTSPO controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the RTSPO database 1019, operating systems, other program components, user interfaces, Web browsers, and/or the like.

Access to the RTSPO database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the RTSPO. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in SQL by instantiating a search string with the proper join/select commands based on the tagged text entries, and the resulting command is provided over the bridge mechanism to the RTSPO as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as buttons, check boxes, cursors, graphical views, menus, scrollers, text fields, and windows (collectively referred to as widgets) similarly facilitate the access, capabilities, operation, and display of data and computer hardware and operating system resources, and status. Operation interfaces are called user interfaces. Graphical user interfaces (GUIs) such as the Apple's iOS®, Macintosh Operating System's Aqua®; IBM's OS/2®; Google's Chrome® (e.g., and other webbrowser/cloud based client OSs); Microsoft's Windows® 2000/2003/3.1/95/98/CE/Millennium/Mobile/NT/Vista/XP/7/X (Server)® (i.e., Aero, Surface, etc.); Unix's X-Windows (e.g., which may include additional Unix graphic interface libraries and layers such as K Desktop Environment (KDE), mythTV and GNU Network Object Model Environment (GNOME), web interface libraries (e.g., ActiveX, AJAX, (D) HTML, FLASH, Java, JavaScript, etc. interface libraries such as, but not limited to, Dojo, jQuery (UI), MooTools, Prototype, script.aculo.us, SWFObject, Yahoo! User Interface®, and/or the like, any of which may be used and) provide a baseline and mechanism of accessing and displaying information graphically to users.

A user interface component 1017 is a stored program component that is executed by a CPU. The user interface may be a graphic user interface as provided by, with, and/or atop operating systems and/or operating environments, and may provide executable library APIs (as may operating systems and the numerous other components noted in the component collection) that allow instruction calls to generate user interface elements such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1018 is a stored program component that is executed by a CPU. The Web browser may be a hypertext viewing application such as Apple's (mobile) Safari®, Google's Chrome®, Microsoft Internet Explorer®, Mozilla's Firefox®, Netscape Navigator®, and/or the like. Secure Web browsing may be supplied with 128 bit (or greater) encryption by way of HTTPS, SSL, and/or the like. Web browsers allowing for the execution of program components through facilities such as ActiveX, AJAX, (D) HTML, FLASH, Java, JavaScript, web browser plug-in APIs (e.g., FireFox®, Safari® Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the RTSPO enabled nodes. The combined application may be nugatory on systems employing Web browsers.

### Mail Server

A mail server component 1021 is a stored program component that is executed by a CPU 1003. The mail server may be an Internet mail server such as, but not limited to: dovecot, Courier IMAP, Cyrus IMAP, Maildir, Microsoft Exchange, sendmail, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects®, and/or the like. The mail server may support communications protocols such as, but not limited to: Internet message access protocol (INAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the RTSPO. Alternatively, the mail server component may be distributed out to mail service providing entities such as Google's® cloud services (e.g., Gmail and notifications may alternatively be provided via messenger services such as AOL's Instant Messenger®, Apple's iMessage®, Google Messenger®, SnapChat®, etc.).

Access to the RTSPO mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1022 is a stored program component that is executed by a CPU 1003. The mail client may be a mail viewing application such as Apple Mail®, Microsoft Entourage®, Microsoft Outlook®, Microsoft Outlook Express®, Mozilla®, Thunderbird®, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1020 is a stored program component that is executed by a CPU 1003, cryptographic processor 1026, cryptographic processor interface 1027, cryptographic processor device 1028, and/or the like. Cryptographic processor interfaces may allow for expedition of encryption and/or decryption requests by the cryptographic component; however, the cryptographic component, alternatively, may run on a CPU and/or GPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component facilitates numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD) 5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), Transport Layer Security (ILS), and/or the like. Employing such encryption security protocols, the RTSPO may encrypt all incoming and/or outgoing communications and may serve as node within a virtual private network (VPN) with a wider communications network. The cryptographic component facilitates the process of “security authorization” whereby access to a resource is inhibited by a security protocol and the cryptographic component effects authorized access to the secured resource. In addition, the cryptographic component may provide unique identifiers of content, e.g., employing an MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to allow the RTSPO component to engage in secure transactions if so desired. The cryptographic component facilitates the secure accessing of resources on the RTSPO and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### Machine Learning (ML)

In one non limiting embodiment, the RTSPO includes a machine learning component 1023, which may be a stored program component that is executed by a CPU 1003. The machine learning component, alternatively, may run on a set of specialized processors, ASICS, FPGAs, GPU's, and/or the like. The machine learning component may be deployed to execute serially, in parallel, distributed, and/or the like, such as by utilizing cloud computing. The machine learning component may employ an ML platform such as Amazon Sage.Maker, Azure Machine Learning, DataRobot AI Cloud, Google AI Platform, IBM Watson® Studio, and/or the like. The machine learning component may be implemented using an ML framework such as PyTorch, Apache MANet, MathWorks Deep Learning Toolbox, scikit-learn, TensorFlow, NGBoost, and/or the like. The machine learning component facilitates training and/or testing of ML prediction logic data structures (e.g., models) and/or utilizing ML prediction logic data structures (e.g., models) to output ML predictions by the RTSPO. The machine learning component may employ various artificial intelligence and/or learning mechanisms such as Reinforcement Learning, Supervised Learning, Unsupervised Learning, and/or the like. The machine learning component may employ ML prediction logic data structure (e.g., model) types such as Bayesian Networks, Classification prediction logic data structures (e.g., models), Decision Trees, Neural Networks (NNs), Regression prediction logic data structures (e.g., models), and/or the like.

### Distributed Immutable Ledger (DIL)

In one non limiting embodiment, the RTSPO includes a distributed immutable ledger component 1024, which may be a stored program component that is executed by a CPU 1003. The distributed immutable ledger component, alternatively, may run on a set of specialized processors, ASICs, FPGAS, GPUs, and/or the like. The distributed immutable ledger component may be deployed to execute serially, in parallel, distributed, and/or the like, such as by utilizing a peer-to-peer network. The distributed immutable ledger component may be implemented as a blockchain (e.g., public blockchain, private blockchain, hybrid blockchain) that comprises cryptographically linked records (e.g., blocks). The distributed immutable ledger component may employ a platform such as Bitcoin, Bitcoin Cash, Dogecoin, Ethereum, Litecoin, Monero, Zcash, and/or the like. The distributed immutable ledger component may employ a consensus mechanism such as proof of authority, proof of space, proof of steak, proof of work, and/or the like. The distributed immutable ledger component may be used to provide functionality such as data storage, cryptocurrency, inventory tracking, non-fungible tokens (NFTs), smart contracts, and/or the like.

### The RTSPO Database

The RTSPO) database component 1019 may be embodied in a database and its stored data. The database is a stored program component, which is executed by the CPU; the stored program component portion configuring the CPU to process the stored data. The database may be a fault tolerant, relational, scalable, secure database such as Claris File Maker®, MySQL®, Oracle®, Sybase®, etc. may be used. Additionally, optimized fast memory and distributed databases such as IBM's Netezza®, MongoDB's MongoDB®, opensource Hadoop®, opensource VoltDB, SAP's Hana®, etc. Relational databases are an extension of a flat file. Relational databases include a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. Alternative key fields may be used from any of the fields having unique value sets, and in some alternatives, even non-unique values in combinations with other fields. More precisely, they uniquely identify rows of a table on the “one” side of a one-to-many relationship.

Alternatively, the RTSPO database may be implemented using various other data-structures, such as an array, hash, (linked) list, struct, structured text file (e.g., XML), table, flat file database, and/or the like. Such data-structures may be stored in memory and/or in (structured) files. In another alternative, an object-oriented database may be used, such as Frontier™, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the RTSPO database is implemented as a data-structure, the use of the RTSPO database 1019 may be integrated into another component such as the RTSPO component 1035. Also, the database may be implemented as a mix of data structures, objects, programs, relational structures, scripts, and/or the like. Databases may be consolidated and/or distributed in countless variations (e.g., see Distributed RTSPO below). Portions of databases, e.g., tables, may be exported and/or imported and thus decentralized and/or integrated.

In another embodiment, the database component (and/or other storage mechanism of the RTSPO) may store data immutably so that tampering with the data becomes physically impossible and the fidelity and security of the data may be assured. In some embodiments, the database may be stored to write only or write once, read many (WORM) mediums. In another embodiment, the data may be stored on distributed ledger systems (e.g., via blockchain) so that any tampering to entries would be readily identifiable. In one embodiment, the database component may employ the distributed immutable ledger component DIL 1024 mechanism.

In one embodiment, the database component 1019 includes several tables representative of the schema, tables, structures, keys, entities and relationships of the described database 1019a-z:
An accounts table 1019a includes fields such as, but not limited to: an accountID, accountOwnerID, accountContactID, assetIDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, account Number, routing Number, link WalletsID, accountPrioritAccountRatio, accountAddress, accountState, accountZIPcode, accountCountry, accountEmail, accountPhone, accountAuthKey, accountIPaddress, accountURLAccessCode, accountPortNo, accountAuthorizationCode, accountAccessPrivileges, accountPreferences, accountRestrictions, and/or the like;
A users table 1019b includes fields such as, but not limited to: a userID, userSSN, taxID, userContactID, accountID, assetIDs, deviceIDs, paymentIDs, transactionIDs, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocialAccountID, contactType, contactRelationship, userPhone, userAddress, userCity, userState, userZIPCode, userCountry, userAuthorizationCode, user AccessPrivilges, userPreferences, userRestrictions, and/or the like (the user table may support and/or track multiple entity accounts on a RTSPO);
An devices table 1019c includes fields such as, but not limited to: deviceID, sensorIDs, accountID, assetIDs, paymentIDs, deviceType, deviceName, deviceManufacturer, deviceModel, deviceVersion, deviceSerialNo, deviceIPaddress, deviceMACaddress, device_ECID, deviceUUID, deviceLocation, deviceCertificate, deviceOS, appIDs, deviceResources, deviceSession, authKey, deviceSecureKey, wallet.AppInstalledFlag, device AccessPrivileges, devicePreferences, deviceRestrictions, hardware_config, software_config, storage_location, sensor_value, pin_reading, data_length, channel_requirement, sensor_name, sensor_model_no, sensor_manufacturer, sensor_type, sensor_serial_number, sensor_power_requirement, device_power_requirement, location, sensor_associated_tool, sensor_dimensions, device_dimensions, sensor_communications_type, device_communications_type, power_percentage, power_condition, temperature_setting, speed_adjust, hold_duration, part_actuation, and/or the like. Device table may, in some embodiments, include fields corresponding to one or more Bluetooth profiles, such as those published at https://www.bluetooth.org/en-us/specification/adopted-specifications, and/or other device specifications, and/or the like;
An apps table 1019d includes fields such as, but not limited to: appID, appName, app Type, app Dependencies, accountID, deviceIDs, transactionID, userID, appStore AuthKey, appStoreAccountID, appStoreIPaddress, appStoreURLaccessCode, appStorePortNo, appAccessPrivileges, appPreferences, appRestrictions, portNum, access_API_call, linked_wallets_list, and/or the like;
An assets table 1019e includes fields such as, but not limited to: assetID, accountID, userID, distributorAccountID, distributorPaymentID, distributorOnwerID, assetOwnerID, assetType, assetSourceDeviceID, assetSourceDeviceType, assetSourceDeviceName, assetSourceDistributionChannelID, assetSourceDistributionChannelType, assetSourceDistributionChannelName, assetTargetChannelID, assetTargetChannelType, asset TargetChannelName, assetName, assetSeriesName, assetSeriesSeason, assetSeriesEpisode, assetCode, assetQuantity, assetCost, assetPrice, asset Value, assetManufactuer, assetModelNo, assetSerialNo, assetLocation, assetAddress, assetState, assetZIPcode, assetState, assetCountry, assetEmail, assetIPaddress, assetURLaccessCode, assetOwner AccountID, subscriptionIDs, assetAuthroizationCode, assetAccess Privileges, assetPreferences, assetRestrictions, assetAPI, assetAPIconnectionAddress, and/or the like;
A payments table 1019f includes fields such as, but not limited to: paymentID, accountID, userID, couponID, couponValue, couponConditions, couponExpiration, paymentType, paymentAccountNo, paymentAccountName, paymentAccountAuthorizationCodes, paymentExpirationDate, paymentCCV, paymentRoutingNo, paymentRouting Type, payment.Address, paymentState, paymentZIPcode, paymentCountry, paymentEmail, paymentAuthKey, paymentIPaddress, paymentURLaccessCode, paymentPortNo, paymentAccessPrivileges, paymentPreferences, payementRestrictions, and/or the like;
An transactions table 1019g includes fields such as, but not limited to: transactionID, accountID, assetIDs, deviceIDs, paymentIDs, transactionIDs, userID, merchantID, transaction Type, transactionDate, transaction Time, transaction Amount, transactionQuantity, transactionDetails, products List, productType, product Title, productsSummary, productParamsList, transactionNo, transactionAccessPrivileges, transactionPreferences, transactionRestrictions, merchantAuthKey, merchantAuthCode, and/or the like;
An merchants table 1019h includes fields such as, but not limited to: merchantID, merchantTaxID, merchanteName, merchantContactUserID, accountID, issuerID, acquirerID, merchantEmail, merchant Address, merchantState, merchantZIPcode, merchantCountry, merchant AuthKey, merchantIPaddress, portNum, merchantURLaccessCode, merchantPortNo, merchantAccessPrivileges, merchantPreferences, merchantRestrictions, and/or the like;
An ads table 1019i includes fields such as, but not limited to: adID, advertiserID, ad.MerchantID, adNetworkID, adName, adTags, advertiser Name, adSponsor, adTime, adGeo, adAttributes, adFormat, adProduct, adText, ad.Media, ad.MediaID, adChannelID, adTag Time, ad AudioSignature, adHash, adTemplateID, adTemplateData, adSourceID, adSource Name, adSourceServerIP, adSourceURL, adSourceSecurity Protocol, adSourceFTP, ad AuthKey, adAccessPrivileges, adPreferences, adRestrictions, adNetworkXchangeID, adNetwork Xchange Name, adNetwork XchangeCost, adNetworkNchange.MetricType (e.g., CPA, CPC, CPM, CTR, etc.), adNetworkXchange.Metric Value, adNetworkXchangeServer, adNetworkXchangePortNumber, publisherID, publisher Address, publisher URL, publisher Tag, publisher Industry, publisher Name, publisherDescription, siteDomain, siteURL, siteContent, siteTag, siteContext, siteImpression, site Visits, siteHeadline, sitePage, siteAdPrice, sitePlacement, sitePosition, bidID, bidExchange, bidOS, bidTarget, bidTimestamp, bidPrice, bidImpressionID, bidType, bidScore, adType (e.g., mobile, desktop, wearable, largescreen, interstitial, etc.), assetID), merchantID, deviceID, userID, accountID, impressionID, impressionOS, impression TimeStamp, impressionGeo, impressionAction, impression Type, impression PublisherID, impression PublisherURL, and/or the like;
An ML, table 1019j includes fields such as, but not limited to: MLID, predictionLogicStructureID, predictionLogicStructureType, predictionLogicStructureConfiguration, predictionLogicStructure TrainedStructure, predictionLogicStructure TrainingData, predictionLogicStructure TrainingDataConfiguration, predictionLogicStructureTestingData, predictionLogicStructure TestingDataConfiguration, predictionLogicStructureOutputData, predictionLogicStructureOutputDataConfiguration, and/or the like;
A profiles table 1019k includes fields such as, but not limited to: profileID, profileType, profileData, associatedUserID, and/or the like;
A market_data table 1019z includes fields such as, but not limited to:
market_data_feed_ID, asset_ID, asset_symbol, asset_name, spot_price, bid_price, ask_price, and/or the like; in one embodiment, the market data table is populated through a market data feed (e.g., Bloomberg's PhatPipe®, Consolidated Quote System® (CQS), Consolidated Tape Association® (CTA), Consolidated Tape System® (CTS), Dun & Bradstreet®, OTC Montage Data Feed® (OMDF), Reuter's Tib®, Triarch®, U'S equity trade and quote market Data®, Unlisted Trading Privileges® (UTP) Trade Data Feed® (UTDF), UTP Quotation Data Feed® (UQDF), and/or the like feeds, e.g., via ITC 2.1 and/or respective feed protocols), for example, through Microsoft's® Active Template Library and Dealing Object Technology's real-time toolkit Rtt.Multi.

In one embodiment, the RTSPO database may interact with other database systems. For example, employing a distributed database system, queries and data access by search RTSPO component may treat the combination of the RTSPO database, an integrated data security layer database as a single database entity (e.g., see Distributed RTSPO below).

In one embodiment, user programs may contain various user interface primitives, which may serve to update the RTSPO. Also, various accounts may require custom database tables depending upon the environments and the types of clients the RTSPO may need to serve. It should be noted that any unique fields may be designated as a key field throughout. In an alternative embodiment, these tables have been decentralized into their own databases and their respective database controllers (i.e., individual database controllers for each of the above tables). The RTSPO may also be configured to distribute the databases over several computer systemizations and/or storage devices. Similarly, configurations of the decentralized database controllers may be varied by consolidating and/or distributing the various database components 1019a-z. The RTSPO may be configured to keep track of various settings, inputs, and parameters via database controllers.

The RTSPO database may communicate to and/or with other components in a component collection, including itself, and/or facilities of the like. Most frequently, the RTSPO database communicates with the RTSPO component, other program components, and/or the like. The database may contain, retain, and provide information regarding other nodes and data.

### The RTSPOs

The RTSPO component 1035 is a stored program component that is executed by a CPU via stored instruction code configured to engage signals across conductive pathways of the CPU and ISICI controller components. In one embodiment, the RTSPO component incorporates any and/or all combinations of the aspects of the RTSPO that were discussed in the previous figures. As such, the RTSPO affects accessing, obtaining and the provision of information, services, transactions, and/or the like across various communications networks. The features and embodiments of the RTSPO discussed herein increase network efficiency by reducing data transfer requirements with the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., may reduce the capacity and structural infrastructure requirements to support the RTSPO's features and facilities, and in many cases reduce the costs, energy consumption/requirements, and extend the life of RTSPO's underlying infrastructure; this has the added benefit of making the RTSPO more reliable. Similarly, many of the features and mechanisms are designed to be easier for users to use and access, thereby broadening the audience that may enjoy/employ and exploit the feature sets of the RTSPO; such ease of use also helps to increase the reliability of the RTSPO. In addition, the feature sets include heightened security as noted via the Cryptographic components 1020, 1026, 1028 and throughout, making access to the features and data more reliable and secure

The RTSPO transforms system progression simulation input, system progression simulation update input datastructure/inputs, via RTSPO components (e.g., RTSPS), into system progression simulation output, system progression simulation update output outputs.

The RTSPO component facilitates access of information between nodes may be developed by employing various development tools and languages such as, but not limited to: Apache® components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, Ruby, shell scripts, SQL commands, web application server extensions, web development environments and libraries (e.g., Microsoft's® ActiveX; Adobe® AIR, FLEX & FLASH; AJAX; (D) HTML; Dojo, Java; JavaScript; jQuery (UI); MooTools; Prototype; script.aculo.us; Simple Object Access Protocol (SOAP); SWFObject; Yahoo!® User Interface; and/or the like), WebObjects®, and/or the like. In one embodiment, the RTSPO server employs a cryptographic server to encrypt and decrypt communications. The RTSPO component may communicate to and/or with other components in a component collection, including itself, and/or facilities of the like. Most frequently, the RTSPO component communicates with the RTSPO database, operating systems, other program components, and/or the like. The RTSPO may contain, communicate, generate, obtain, and/or provide program component, system, user, and/or data communications, requests, and/or responses.

### Distributed RTSPOs

The structure and/or operation of any of the RTSPO node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion. As such, a combination of hardware may be distributed within a location, within a region and/or globally where logical access to a controller may be abstracted as a singular node, yet where a multitude of private, semiprivate and publicly accessible node controllers (e.g., via dispersed data centers) are coordinated to serve requests (e.g., providing private cloud, semi-private cloud, and public cloud computing resources) and allowing for the serving of such requests in discrete regions (e.g., isolated, local, regional, national, global cloud access, etc.).

Thus, RTSPO may be implemented with varying functional, logical, operational, organizational, structural and/or topological modifications may be made without departing from the scope and/or spirit of the disclosure. For example, unless expressly described otherwise, it is to be understood that the logical and/or topological structure of any combination of any program components (e.g., of the component collection), other components, data flow order, logic flow order, and/or any present feature sets as described in the figures and/or throughout are not limited to a fixed operating order and/or arrangement, but rather, any disclosed order is exemplary and all equivalents, and the components may execute at the same or different processors. Furthermore, it is to be understood that such features are not limited to serial execution, but rather, any number of threads, processes, services, servers, and/or the like that may execute asymmetrically, asynchronously, concurrently, in parallel, symmetrically, simultaneously, synchronously, and/or the like may take place depending on how the components and even individual methods and/or functions are called. For example, in any of the dataflow and/or logic flow descriptions, any individual item and/or method and/or function called may only execute serially and/or asynchronously in a small deployment on a single core machine, but may be executed concurrently, in parallel, simultaneously, synchronously (as well as asynchronously will still concurrent, in parallel, and/or simultaneously) when deployed on multicore processor or even across multiple machines and in and from multiple machines and geographic regions.

As such, the component collection may be consolidated and/or distributed in countless variations through various data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so as discussed through the disclosure and/or through various other data processing communication techniques. Furthermore, any part of sub parts of the RTSPO node controller's component collection may be executed on at least one processing unit, where that processing unit may be a sub-unit of a CPU, a core, an entirely different CPU and/or sub-unit at the same location or remotely at a different location, and/or across many multiple such processing units. For example, for load-balancing reasons, parts of the component collection may start to execute on a given CPU core, then the next execution element of the component collection may be moved to execute on another CPU core, on the same, or completely different CPU at the same or different location, e.g., because the CPU may become over taxed with instruction executions, and as such, a scheduler may move instructions at the taxed CPU and/or CPU sub-unit to another CPU and/or CPU sub-unit with a lesser instruction execution load. As such, it may be difficult to predict on which CPU and/or processing sub-unit a process instruction begins to execute and where it will continue and/or conclude execution, as it may be on the same or completely different CPU and/or processing sub-unit.

The configuration of the RTSPO controller may depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like. For example, cloud services such as Amazon Data Services®, Microsoft Azure®, Hewlett Packard Helion®, IBM® Cloud services allow for RTSPO controller and/or RTSPO component collections to be hosted in full or partially for varying degrees of scale.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D) COM), (Distributed) Object Linking and Embedding ((D) OLE), and/or the like), Common Object Request Broker Architecture (CORBA), Jini local and remote application program interfaces, JavaScript Object Notation (JSON), NeXT Computer, Inc.'s (Dynamic) Object Linking, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as JSON, lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1
where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration may depend upon the context, environment, and requirements of system deployment.

For example, in some implementations, the RTSPO controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via an SSL connection, parse the data to extract variables, and store the data to a database, is provided below:

```
<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
  $input = “”;
  $input = socket_read($client, 1024);
  $data .= $input;
} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm. IBMDI. doc/referenceguide295.htm
   and other parser implementations:
http://publib.boulder.ibm.com/infocenter/tivihelp/v2r1/index.jsp?topic=/com.ibm. IBMDI.doc/referenceguide259.htm
   all of which are hereby expressly incorporated by reference.

In order to address various issues and advance the art, the entirety of this application for Real-Time System Progression Optimizer Apparatuses, Processes and Systems (including the Cover Page, Title, Headings, Field, Background, Summary, Brief Description of the Drawings, Detailed Description, Claims, Abstract, Figures, Appendices, and otherwise) shows, by way of illustration, various non-limiting example embodiments in which the claimed innovations may be practiced. The advantages and features described in the application are of a representative sample of embodiments only, and are not exhaustive and/or exclusive. They are presented to assist in understanding and teach the claimed principles. It should be noted that to the extent any financial and/or investment examples are included, such examples are for illustrative purpose(s) only, and are not, nor should they be interpreted, as investment advice. As such, all examples and/or embodiments are deemed to be non-limiting throughout this disclosure; it should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It may be appreciated that many of those undescribed embodiments incorporate and/or be based of same principles of the innovations and others are equivalent. As such, no inference should be drawn regarding those embodiments discussed herein relative to those not discussed herein other than it is as such for purposes of reducing space and repetition. Consequently, terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should not be construed to limit embodiments, and instead, again, are offered for convenience of description of orientation and/or convenience of reference, and as such, do not require that any embodiments be constructed or operated in a particular orientation unless explicitly indicated as such. Terms such as “attached”, “affixed”, “connected”, “coupled”, “interconnected”, etc. may refer to a relationship where structures are secured or attached to one another either directly or indirectly through intervening structures, as well as both movable or rigid attachments or relationships, unless expressly described otherwise. Similarly, descriptions of embodiments disclosed throughout this disclosure, any reference to direction or orientation is merely intended for convenience of description and/or of reference and is not intended in any way to limit the scope of described embodiments. Furthermore, it is to be understood, unless expressly described otherwise, that other embodiments may be utilized and functional, logical, operational, organizational, structural and/or topological modifications may be made without departing from the scope and/or spirit of the disclosure. For instance, unless expressly described otherwise, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Also, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure (e.g., see Distributed RTSPO for examples). Consequently, some of these features may be mutually contradictory, in that they cannot be simultaneously present in a single embodiment. Similarly, some features may be applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, provisionals, re-issues, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a RTSPO individual and/or enterprise user, database configuration and/or relational model, data type, data transmission and/or network framework, library, syntax structure, and/or the like, various embodiments of the RTSPO, may be implemented that allow a great deal of flexibility and customization. While various embodiments and discussions of the RTSPO have included information technology, however, it is to be understood that the embodiments described herein may be readily configured and/or customized for a wide variety of other applications and/or implementations. For example, aspects of the RTSPO also may be adapted for any backend system that is compute and/or time intensive (e.g., weather modelling systems, financial pricing systems, and any other output for which simulation may be used), for anomaly detection for complex systems, and/or the like.

What is claimed is:

1. A real-time system progression simulation interaction apparatus, comprising:
at least one memory;
a component collection stored in the at least one memory;
at least one processor disposed in communication with the at least one memory, the at least one processor executing processor-executable instructions from the component collection, the component collection storage structured with processor-executable instructions, comprising:
obtain, via the at least one processor, a system progression simulation request datastructure structured as specifying a set of initial scenario parameters values for a set of scenario parameters;
determine, via the at least one processor, for each respective scenario parameter in the set of scenario parameters, a set of parameter evaluation values for the respective scenario parameter, in which each parameter evaluation value in the set of parameter evaluation values for the respective scenario parameter is within an interval specified by a set of boundary values for the respective scenario parameter;
determine, via the at least one processor, a set of scenario evaluation points, in which each scenario evaluation point in the set of scenario evaluation points is structured as an intersection of parameter evaluation values from each of the determined sets of parameter evaluation values;
compute, via the at least one processor, for each respective scenario evaluation point in the set of scenario evaluation points, a scenario result value for the respective scenario evaluation point via a system progression simulation;
determine, via the at least one processor, a set of surface descriptor datastructures, in which each surface descriptor datastructure in the set of surface descriptor datastructures is structured as specifying a set of surface points defining a surface;
generate, via the at least one processor, for each respective surface descriptor datastructure in the set of surface descriptor datastructures, a scenario evaluation datastructure structured as specifying an evaluation function determined via interpolation on a set of surface points specified by the respective surface descriptor datastructure;
determine, via the at least one processor, a first generated scenario evaluation datastructure matching the set of initial scenario parameters values; and
determine, via the at least one processor, a scenario result value for the set of initial scenario parameters values via an evaluation function specified by the first matching scenario evaluation datastructure.

2. The apparatus of claim 1, in which a set of boundary values for a scenario parameter comprises a minimum value and a maximum value.

3. The apparatus of claim 1, in which a set of boundary values for a scenario parameter is determined via a set of default values.

4. The apparatus of claim 1, in which a set of boundary values for a scenario parameter is determined via a calculation that utilizes an initial scenario parameters value corresponding to the scenario parameter.

5. The apparatus of claim 1, in which a set of parameter evaluation values for a scenario parameter comprises equally spaced points along the interval associated with the scenario parameter.

6. The apparatus of claim 1, in which the system progression simulation is structured as computing a scenario result value for a scenario evaluation point via a calculation that utilizes parameter evaluation values specified by the scenario evaluation point.

7. The apparatus of claim 1, in which scenario result values for the set of scenario evaluation points are computed in parallel.

8. The apparatus of claim 1, in which a surface point specified by a surface descriptor datastructure comprises parameter evaluation values of a corresponding scenario evaluation point and a computed scenario result value for the corresponding scenario evaluation point.

9. The apparatus of claim 1, in which the surface is a quadratic surface.

10. The apparatus of claim 1, in which a scenario evaluation datastructure comprises a coefficients datastructure structured as specifying coefficients of a bilinear function.

11. The apparatus of claim 1, in which the component collection storage is further structured with processor-executable instructions, comprising:
generate, via the at least one processor, a system progression simulation response datastructure structured as specifying a result value determined via a calculation that utilizes the scenario result value for the set of initial scenario parameters values.

12. The apparatus of claim 11, in which the system progression simulation request datastructure is structured as specifying a goal value, and in which the system progression simulation response datastructure is structured as specifying a result score determined via a calculation that utilizes the scenario result value for the set of initial scenario parameters values and the goal value.

13. The apparatus of claim 1, in which the component collection storage is further structured with processor-executable instructions, comprising:
obtain, via the at least one processor, a system progression simulation update request datastructure structured as specifying a set of updated scenario parameters values for the set of scenario parameters;
determine, via the at least one processor, a second generated scenario evaluation datastructure matching the set of updated scenario parameters values; and
determine, via the at least one processor, a scenario result value for the set of updated scenario parameters values via an evaluation function specified by the second matching scenario evaluation datastructure.

14. The apparatus of claim 13, in which the component collection storage is further structured with processor-executable instructions, comprising:
generate, via the at least one processor, a system progression simulation update response datastructure structured as specifying a result value determined via a calculation that utilizes the scenario result value for the set of updated scenario parameters values.

15. The apparatus of claim 13, in which the first generated scenario evaluation datastructure and the second generated scenario evaluation datastructure are identical.

16. A real-time system progression simulation interaction processor-readable, non-transient medium, the medium storing a component collection, the component collection storage structured with processor-executable instructions comprising:
obtain, via the at least one processor, a system progression simulation request datastructure structured as specifying a set of initial scenario parameters values for a set of scenario parameters;
determine, via the at least one processor, for each respective scenario parameter in the set of scenario parameters, a set of parameter evaluation values for the respective scenario parameter, in which each parameter evaluation value in the set of parameter evaluation values for the respective scenario parameter is within an interval specified by a set of boundary values for the respective scenario parameter;
determine, via the at least one processor, a set of scenario evaluation points, in which each scenario evaluation point in the set of scenario evaluation points is structured as an intersection of parameter evaluation values from each of the determined sets of parameter evaluation values;
compute, via the at least one processor, for each respective scenario evaluation point in the set of scenario evaluation points, a scenario result value for the respective scenario evaluation point via a system progression simulation;
determine, via the at least one processor, a set of surface descriptor datastructures, in which each surface descriptor datastructure in the set of surface descriptor datastructures is structured as specifying a set of surface points defining a surface;
generate, via the at least one processor, for each respective surface descriptor datastructure in the set of surface descriptor datastructures, a scenario evaluation datastructure structured as specifying an evaluation function determined via interpolation on a set of surface points specified by the respective surface descriptor datastructure;
determine, via the at least one processor, a first generated scenario evaluation datastructure matching the set of initial scenario parameters values; and
determine, via the at least one processor, a scenario result value for the set of initial scenario parameters values via an evaluation function specified by the first matching scenario evaluation datastructure.

17. A real-time system progression simulation interaction processor-implemented system, comprising:
means to store a component collection;
means to process processor-executable instructions from the component collection, the component collection storage structured with processor-executable instructions including:
obtain, via the at least one processor, a system progression simulation request datastructure structured as specifying a set of initial scenario parameters values for a set of scenario parameters;
determine, via the at least one processor, for each respective scenario parameter in the set of scenario parameters, a set of parameter evaluation values for the respective scenario parameter, in which each parameter evaluation value in the set of parameter evaluation values for the respective scenario parameter is within an interval specified by a set of boundary values for the respective scenario parameter;
determine, via the at least one processor, a set of scenario evaluation points, in which each scenario evaluation point in the set of scenario evaluation points is structured as an intersection of parameter evaluation values from each of the determined sets of parameter evaluation values;
compute, via the at least one processor, for each respective scenario evaluation point in the set of scenario evaluation points, a scenario result value for the respective scenario evaluation point via a system progression simulation;
determine, via the at least one processor, a set of surface descriptor datastructures, in which each surface descriptor datastructure in the set of surface descriptor datastructures is structured as specifying a set of surface points defining a surface;
generate, via the at least one processor, for each respective surface descriptor datastructure in the set of surface descriptor datastructures, a scenario evaluation datastructure structured as specifying an evaluation function determined via interpolation on a set of surface points specified by the respective surface descriptor datastructure;
determine, via the at least one processor, a first generated scenario evaluation datastructure matching the set of initial scenario parameters values; and
determine, via the at least one processor, a scenario result value for the set of initial scenario parameters values via an evaluation function specified by the first matching scenario evaluation datastructure.

18. A real-time system progression simulation interaction processor-implemented process, including processing processor-executable instructions via at least one processor from a component collection stored in at least one memory, the component collection storage structured with processor-executable instructions comprising:
obtain, via the at least one processor, a system progression simulation request datastructure structured as specifying a set of initial scenario parameters values for a set of scenario parameters;
determine, via the at least one processor, for each respective scenario parameter in the set of scenario parameters, a set of parameter evaluation values for the respective scenario parameter, in which each parameter evaluation value in the set of parameter evaluation values for the respective scenario parameter is within an interval specified by a set of boundary values for the respective scenario parameter;
determine, via the at least one processor, a set of scenario evaluation points, in which each scenario evaluation point in the set of scenario evaluation points is structured as an intersection of parameter evaluation values from each of the determined sets of parameter evaluation values;
compute, via the at least one processor, for each respective scenario evaluation point in the set of scenario evaluation points, a scenario result value for the respective scenario evaluation point via a system progression simulation;
determine, via the at least one processor, a set of surface descriptor datastructures, in which each surface descriptor datastructure in the set of surface descriptor datastructures is structured as specifying a set of surface points defining a surface;
generate, via the at least one processor, for each respective surface descriptor datastructure in the set of surface descriptor datastructures, a scenario evaluation datastructure structured as specifying an evaluation function determined via interpolation on a set of surface points specified by the respective surface descriptor datastructure;
determine, via the at least one processor, a first generated scenario evaluation datastructure matching the set of initial scenario parameters values; and
determine, via the at least one processor, a scenario result value for the set of initial scenario parameters values via an evaluation function specified by the first matching scenario evaluation datastructure.
